(19) United States
(12) Patent Application Publication
(10) Pub. No.: US 2025/0286407 A1
(43) Pub. Date: Sep. 11, 2025

(54) WIRELESS POWER TRANSFER IN A BEARING

(71) Applicant: Solace Power Inc., Mount Pearl (CA)

(72) Inventors: Samer ALDHAHER, London (GB); Medhi MASOUDI, St Johns (CA); Jean-Robert DESROSIERS, St Johns (CA); Thomas SEARY, Mount Pearl (CA); Stephen SPENCER, Mount Pearl (CA)

(73) Assignee: Solace Power Inc., Mount Pearl, NL (CA)

(21) Appl. No.: 19/070,895

(22) Filed: Mar. 5, 2025

Related U.S. Application Data
(60) Provisional application No. 63/561,645, filed on Mar. 5, 2024.

(51) Int. Cl. H02J 50/12; H02K 7/08; H02K 11/00; H02K 11/01; H02K 11/33

(52) U.S. Cl. CPC H02J 50/12; H02K 7/08; H02K 11/0094; H02K 11/01; H02K 11/33

(57) ABSTRACT

There is provided a bearing comprising an inner race, an outer race and one or more roller elements positioned radially between the inner and outer races. The bearing further comprises a wireless power transfer system affixed to or integrally formed with the at least one of the races.

### CROSS-REFERENCE TO RELATED APPLICATION

This application claims the benefit of U.S. Provisional Application No. 63/561,645 filed on 5 Mar. 2024, the entire content of which is incorporated herein by reference.

### FIELD

The subject disclosure relates generally to wireless power transfer, and in particular to a wireless power transfer in a bearing.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

Various wireless power transfer systems are known. A typical wireless power transfer system includes a power source electrically connected to a wireless power transmitter, and a wireless power receiver electrically connected to a load.

In magnetic induction systems, the transmitter has a transmitter coil with a certain inductance that transfers electrical energy from the power source to the receiver, which has a receiver coil with a certain inductance. Power transfer occurs due to coupling of magnetic fields between the coils or inductors of the transmitter and receiver. The range of these magnetic induction systems is limited, and the coils or inductors of the transmitter and receiver must be tightly coupled, i.e., have a coupling factor above 0.5 and be in optimal alignment for efficient power transfer.

There also exist resonant magnetic systems in which power is transferred due to coupling of magnetic fields between the coils or inductors of the transmitter and receiver. The transmitter and receiver inductors may be loosely coupled, i.e., have a coupling factor below 0.5. However, in resonant magnetic systems the inductors are resonated using at least one capacitor. Furthermore, in resonant magnetic systems, the transmitter is self-resonant and the receiver is self-resonant. The range of power transfer in resonant magnetic systems is increased over that of magnetic induction systems and alignment issues are rectified. While electromagnetic energy is produced in magnetic induction and resonant magnetic systems, the majority of power transfer occurs via the magnetic field. Little, if any, power is transferred via electric induction or resonant electric induction.

In electrical induction systems, the transmitter and receiver have capacitive electrodes. Power transfer occurs due to coupling of electric fields between the capacitive electrodes of the transmitter and receiver. Similar, to resonant magnetic systems, there exist resonant electric systems in which the capacitive electrodes of the transmitter and receiver are made resonant using at least one inductor. The inductor may be a coil. In resonant electric systems, the transmitter is self-resonant and the receiver is self-resonant. Resonant electric systems have an increased range of power transfer compared to that of electric induction systems and alignment issues are rectified. While electromagnetic energy is produced in electric induction and resonant electric systems, the majority of power transfer occurs via the electric field. Little, if any, power is transferred via magnetic induction or resonant magnetic induction.

While some wireless power transfer systems are known, improvements are desired. It is therefore an object to provide a novel wireless power transfer transmitter, receiver, system and method of wirelessly transferring power.

This background serves only to set a scene to allow a person skilled in the art to better appreciate the following description. Therefore, none of the above discussion should necessarily be taken as an acknowledgement that the discussion is part of the state of the art or is common general knowledge. One or more aspects/embodiments of the invention may or may not address one or more of the background issues.

### SUMMARY

Accordingly, in an aspect there is provided a bearing comprising an inner race, an outer race and one or more roller elements positioned radially between the inner and outer races, the bearing further comprising:
a wireless power transfer system at least partially enclosed between the races.

The wireless power transfer system, or at least a portion thereof may be enclosed between the inner and outer race. The system may transfer electrical power between a components (e.g., a transmitter and a receiver) of the system. Power may be transferred mostly, if not entirely, within between the inner and outer race, i.e., within a volume defined by the inner and outer race.

The wireless power transfer system may comprise a transmitter for generating a magnetic field.

The transmitter may comprise a coil positioned radially adjacent one of the races.

The coil may be positioned radially adjacent the outer race. The coil may encircle the inner race. The coil may be positioned axially adjacent the outer race.

The coil may be mounted to a support radially adjacent one of the races. The support may encircle the inner race. The support may comprise nonconductive material. The nonconductive material may comprise Acrylonitrile Butadiene Styrene (ABS), polycarbonate, polyethylene, and/or nylon. The support may comprise reinforcing materials. The reinforcing material may reinforce the nonconductive material. The reinforcing material may comprise glass.

The coil and/or support may be enclosed by an additional member. The member may provide for structural support against centrifugal forces which may be present at high RPM's. The member may be a metal member which secures the coil and/or support to the outer race. The member may take the form of a housing and may provide support to the PCB, and the support.

The support may span a longitudinal length of the races. The longitudinal axis of the support may be parallel to a longitudinal axis of the races, e.g., the outer race.

The coil may comprise a plurality of windings. The coil may comprise, e.g., be constructed using, magnet wire, litz wire (e.g., twisted multi-strand wire), copper traces, and/or conductive metal electroplated substrates. The windings may be embedded in the support.

The plurality of windings may be aligned in a direction parallel to a longitudinal axis of the races. The windings may be embedded in the support. The windings may be wrapped around a circumference of the support in a helical manner. The windings may be embedded or over-moulded into the support. The support may be plastic. The coil and the support may be press-fitted and/or adhered to one of the races, e.g., the outer race.

The transmitter further may further comprise a shield for limiting penetration of the generated magnetic field into at least one of the races. The shield may be for limiting penetration of the generated magnetic field into the outer race.

The shield may focus a field generated by the transmitter to other components of the system, a receiver for extracting from a generated field. Focusing the field towards receiver of the system may improve wireless power transfer efficiency.

The shield may be radially adjacent the support. The bearing, e.g., one or more of the races, may be made of steel. Steel is lossy in terms of electromagnetic fields. This may be beneficial for bearing functionality, but not for electrical power transfer. As such, the shield may limit a magnetic field generated by the transmitter to the volume between the races such that power transfer efficiency is improved.

The shield may be adhered, press fit, stamped, or electro-plated to the support, or to one of the races, e.g., the outer race. The shield may additionally or alternatively be made of copper tape, or aluminium.

The shield may form a surface of the support proximate one of the races, e.g., the outer race.

The transmitter may further comprise electronics electrically connected to the coil. The electronics may comprise inductors, resistors, and/or capacitors. The electronics may comprise a DC/DC converter, inverter, and/or output stage. The DC/DC converter and the inverter may be integrated into a single unit. Examples of a combined DC/DC converter and inverter are described in applicant's U.S. Provisional Application No. 63/539,974, the relevant portions of which are incorporated herein by reference.

The electronics may be positioned at one longitudinal end of the bearing races.

The electronics may be mounted to a printed circuit board (PCB). The electronics on the PCB may be embedded in a heat dispersion material. For example, the electronics may be buried in die. Thermal paths on the PCBs may be created around the electronics using thermal vias. This may dissipate heat away from the electronics. The vias may be copper. The heat dispersion material may have a puck shape. The heat dispersion material may enclose the electronics. The heat dispersion material may comprise one or more openings allowing for external connections and/or mounting to the PCB.

The PCB may be positioned at one longitudinal end of the bearing races.

The wireless power transfer system may comprise a receiver from extracting electrical power from a generated magnetic field.

The receiver may comprise a coil positioned radially adjacent one of the races.

The coil of the receiver may be positioned radially adjacent the inner race. The receiver coil may encircle the inner race. The coil may be positioned axially adjacent the inner race.

The coil of the receiver may be mounted to a support radially adjacent one of the races. The support may encircle the inner race. The support may comprise nonconductive material. The nonconductive material may comprise Acrylonitrile Butadiene Styrene (ABS), polycarbonate, polyethylene, and/or nylon. The support may comprise reinforcing materials. The reinforcing material may reinforce the nonconductive material. The reinforcing material may comprise glass.

The coil and/or support may be enclosed by an additional member. The member may provide for structural support against centrifugal forces which may be present at high at high RPM's. The member may be a metal member which secures the coil and/or support to the outer race. The member may take the form of a housing and may provide support to the PCB, and the support.

The receiver support may span a longitudinal length of the races. The longitudinal axis of the support may be parallel to a longitudinal axis of the races, e.g., the inner race. The support may have a longitudinal axis which is perpendicular to a main longitudinal axis of the races, e.g., the inner race.

The coil of the receiver may comprise a plurality of windings. The receiver coil may comprise, e.g., be constructed using, magnet wire, litz wire (e.g., twisted multi-strand wire), copper traces, and/or conductive metal electroplated substrates. The windings may be embedded in the support.

The plurality of windings may be aligned in a direction parallel to a longitudinal axis of the races. The windings may be embedded in the support. The windings may be wrapped around a circumference of the support in a helical manner. The windings may be embedded or over-moulded into the support. The support may be plastic. The coil and the support may be press-fitted and/or adhered to one of the races, e.g., the inner race.

The receiver may further comprise a shield for limiting penetration of a generated magnetic field into at least one of the races. The shield may be for limiting penetration of the generated magnetic field into the inner race.

The shield may focus a field generated by a transmitter to the receiver for extracting electrical power from a generated field. Focusing a magnetic field towards the receiver of the system may improve wireless power transfer efficiency.

The shield may be radially adjacent the support. The bearing, e.g., one or more of the races, may be made of steel. Steel is lossy in terms of electromagnetic fields. This may be beneficial for bearing functionality, but not for electrical power transfer. As such, the shield may limit a magnetic field generated by a transmitter to the volume between the races such that power transfer efficiency is improved.

The shield may be adhered, press fit, stamped, or electro-plated to the support, or to one of the races, e.g., the outer race. The shield may additionally or alternatively be made of copper tape, or aluminium.

The shield may form a surface of the support proximate one of the races, e.g., the inner race.

The receiver may further comprise electronics electrically connected to the coil of the receiver.

The electronics may comprise inductors, resistors, and/or capacitors. The electronics may comprise a DC/DC converter, rectifier, synchronous rectifier, and/or input stage.

The electronics may be positioned at one longitudinal end of the bearing races.

The electronics may be mounted to a printed circuit board (PCB). The electronics on the PCB may be embedded in a heat dispersion material. For example, the electronics may be buried in die. Thermal paths on the PCBs may be created around the electronics using thermal vias. This may dissipate heat away from the electronics. The vias may be copper. The heat dispersion material may have a puck shape. The heat dispersion material may enclose the electronics. The heat dispersion material may comprise one or more openings allowing for external connections and/or mounting to the PCB.

The PCB of the receiver may be positioned at one longitudinal end of the bearing races.

The bearing may further comprise an end cap at a longitudinal end of the bearing races. The end cap may be generally perpendicular to the longitudinal axis of the races. The end cap may enclose a volume defined between the races. The end cap may be lined with a shield. The shield may be similar to the transmitter and/or receiver shields.

The PCB of the transmitter may be affixed to the end cap. The PCB may be affixed to an outer surface of the end cap. At least a portion of the inner surface of the end cap may be within the volume defined between the races while the outer surface is not within the volume.

The bearing may further comprise one or more roller elements positioned between the inner and outer races.

The races, transmitter and receiver may/or be encircled by an outer housing such that they are enclosed by the outer housing. The housing may be generally cylindrical. The housing may be hollow. The outer housing may have a radius that is greater than a radius of each one of the inner and outer races.

Further, the inner race may encircle an inner housing such that the inner race encloses the inner housing. The inner housing may be cylindrical. The inner housing may be hollow. The inner housing may have a smaller radius than the outer housing. The outer housing may define an outer dimension of the bearing. A shaft may pass through the inner housing. The shaft may be connected to a rotor of a motor, such as an electrical motor. The shaft may be a drive shaft. The inner housing may have a radius that is less than a radius of the inner and outer races. The outer race may have a radius that is greater than the inner race.

The shaft may be shielded. A shield may be placed around the circumference of the shaft along at least a portion of the shaft. For example, the shield may comprise copper tape wrapped around the circumference of the shaft. The tape may be wrapped around a longitudinal portion of the shaft. The longitudinal portion may correspond with an axial position of the inner race. The shaft may be made of the steel. As such, the shield may prevent penetration of a magnetic field into the shaft which may negatively impact wireless power transfer efficiency.

According to another aspect there is provided a motor comprising a drive shaft and any of the described bearings, the bearing enclosing the drive shaft. The motor may comprise an electric motor. The electric motor may comprise a stator and/or rotor. The shaft may pass through a central aperture defined by the inner race. The races may encircle the shaft.

According to another aspect there is provided a transmitter positioned at least partially between bearing races enclosing one or more roller elements, the transmitter comprising a coil mounted to a support radially adjacent a race of a bearing, the coil for generating a magnetic field for transferring electrical power. The coil may be mounted to the support radially adjacent an outer race of the bearing. The transmitter may comprise any of the previously described transmitter components.

According to another aspect there is provided a receiver positioned at least partially between bearing races enclosing one or more roller elements, the receiver comprising a coil mounted to a support radially adjacent a race of a bearing, the coil for extracting electrical power from a generated magnetic field. The coil may be mounted to the support radially adjacent an inner race of the bearing. The receiver may comprise any of the previously described receiver components.

According to another aspect there is provided a wireless power transfer system comprising:
a transmitter positioned at least partially between bearing races enclosing one or more roller elements, the transmitter comprising a coil mounted to a support radially adjacent a race of a bearing, the coil for generating a magnetic field for transferring electrical power; and
a receiver positioned at least partially between the bearing races, the receiver comprising a coil mounted to a support radially adjacent one of the bearing races, the coil of the receiver for extracting electrical power from the generated magnetic field.

The transmitter coil may be mounted to the support radially adjacent an outer race of the bearing. The transmitter may comprise any of the previously described transmitter components. The receiver coil may be mounted to the support radially adjacent an inner race of the bearing. The receiver may comprise any of the previously described receiver components.

According to another aspect there is provided a method of transferring electrical power wirelessly within a bearing comprising an inner race, an outer race and one or more roller elements positioned radially between the inner and outer races, the bearing further comprising a wireless power transfer system at least partially enclosed between the races, the method comprising:
generating an electrical field, via a transmitter positioned at least partially between bearing races, to transfer electrical power to a receiver positioned at least partially between the bearing races.

According to another aspect there is provided a method of transferring electrical power wirelessly within a bearing comprising an inner race, an outer race and one or more roller elements positioned radially between the inner and outer races, the bearing further comprising a wireless power transfer system at least partially enclosed between the races, the method comprising:
extracting electrical power, via a receiver positioned at least partially between bearing races, from a magnetic field generated by a transmitter positioned at least partially between the bearing races.

According to another aspect there is provided a bearing comprising an inner race, an outer race and one or more roller elements positioned radially between the inner and outer races, the bearing further comprising:
a wireless power transfer system affixed to or integrally formed with at least one of the inner and outer races.

By affixing or integrally forming the wireless power transfer system (or a portion thereof) to at least one race, when one race rotates relative to another power may still be transferred by a transmitter and a receiver of the system. More specifically, by affixing or integrally forming a transmitter and/or receiver of the system to one of the races, power may be transferred from the transmitter to the receiver even during rotation of the races. The transmitter and receiver may be affixed or integrally formed with the race such that the transmitter and receiver are at least partially aligned in the radial plane such that power may be transferred from the transmitter to the receiver even during relative rotation of the races.

While the wireless power transfer system has been described as being affixed to one of the inner and outer races, the wireless power transfer system may be integrally formed with one of the inner and outer races. The wireless power transfer system and respective race may be integrally formed via additive manufacturing.

The wireless power transfer system may be affixed to an inner race. A portion of the system may be affixed to the inner race, and a portion of the system may be affixed to the outer race. For example, a receiver of the wireless power transfer may be affixed to the inner race while a transmitter of the system is affixed to the outer race.

The system may comprise a transmitter for generating a magnetic field for transferring electrical power via magnetic field coupling.

The transmitter may be affixed to the outer race.

The transmitter may comprise a coil, i.e., a transmitter coil. The transmitter coil may be positioned axially adjacent to one of the races. The transmitter coil may be positioned at longitudinal end of one or both of the races. The transmitter coil may have a radial axis and each of the races may have the same radial axis. In other words, the transmitter coil and races may be centred about the same axis while the transmitter is longitudinally or axially adjacent at least one of the races.

The transmitter coil may comprise a plurality of windings. The windings may be generally parallel in the same radial direction as the races. The windings may form a plane which is generally parallel with a radial direction of the races. The transmitter coil may have a greater number of windings that a corresponding receiver coil of the wireless power transfer system. For example, the transmitter coil may have a 2 to 1 ratio of windings compared to the receiver coil. Further, the windings of the transmitter coil may be stacked in the radial direction. For example, the transmitter coil may comprise a first layer of longitudinally adjacent windings and a second layer of longitudinally adjacent windings radially stacked on the first layer. The second layer of windings may have a greater radius than the first layer of windings. Stacking windings in this manner may increase the magnetic field generated by the transmitter without increasing the overall longitudinal thickness or length of the windings of the transmitter coil.

The windings of the transmitter coil may have a wider profile than a profile of windings of a corresponding receiver coil of a receiver of the wireless power transfer system. In other words, individual windings of the transmitter coil may be wider than individual windings of the receiver coil such that the overall longitudinal distance of the transmitter coil is greater than the overall longitudinal distance of the receiver coil. Alternatively or additionally, each winding of the transmitter and receiver coils may have the same profile, but the transmitter coil may comprise a greater number of windings than the receiver coil. For example, the transmitter coil may comprise 5 longitudinally arranged windings while the receiver coil comprises 4 longitudinally arranged windings. The person of skill in the art will appreciate any number of windings may be used depending on the power requirements and space considerations. The windings of the transmitter coil may span a greater longitudinal distance than the windings of the receiver coil while encircling the receiver. By spanning a greater longitudinal distance the transmitter coil may be more tolerant to at least partial misalignment between the transmitter and receiver coils caused by rotation of one or more of the races, or other factors.

Additionally, by minimising the number of windings of the receiver coil while having more windings in the transmitter coil, power losses via heat generation at the receiver coil may be minimized. It may be preferable to increase the number of windings or turns of a receiver coil to as high as possible to capture as much of a magnetic field generated by a transmitter coil. However, increasing the number of windings may increase losses and cause heat generation. Accordingly, minimising the number of windings of the receiver coil while still maximising the magnetic field captured (and accordingly the electrical power transferred) by having a greater number of windings, overhanging windings, or layers of windings in the transmitter coil may ensure losses are minimised without impacting power transfer.

The transmitter coil may be opposite to a receiver coil of a receiver of the system. A plane formed by the transmitter coil may be perpendicular to a plane of a longitudinal axis of the races. The plane of the transmitter coil may be parallel to a plane formed by a receiver coil of a receiver of the system. The transmitter coil may enclose the receiver coil. In particular, the transmitter coil may have a greater radius than the receiver coil.

The transmitter coil may be affixed to an end cap which encloses the transmitter via a support. Windings of the coil may be embedded in the support.

Windings of the transmitter coil may be affixed to a support or coil holder. The holder may be take the form a ring or hollow cylinder. The windings of the transmitter coil may be wrapped or wound around the outside of the transmitter coil. The windings of the transmitter coil may be positioned on an outer surface of the support or coil holder. The transmitter support may be generally axially aligned with a corresponding receiver holder of a receiver of the wireless power transfer system. The transmitter support may be affixed to an outer housing or flange. The outer housing or flange may be affixed to the outer race of the bearing. The outer housing or flange may enclose (encircle) the outer race, inner race and roller elements therebetween.

The transmitter may further comprise a PCB. Transmitter electronics may be affixed to the PCB. The PCB may be affixed to an inner surface of an end cap which encloses the transmitter. The PCB may be positioned between the transmitter coil and the end cap. The PCB may be affixed the described outer housing or flange. The PCB may be radially aligned with the transmitter support or holder. The PCB may take the form of a ring or disc with a hole in the centre. The outer radius of the PCB may be less than or equal to an outer radius of the outer housing or flange. The inner radius of the PCB may be greater than or equal to an inner radius of the outer housing or flange.

The system may comprise a receiver for extracting electrical power via magnetic field coupling from a generated magnetic field.

The receiver may be affixed to the inner race.

The receiver may comprise a receiver coil. The receiver coil may comprise a plurality of windings. The windings may be generally parallel to, i.e., in the same radial direction as, the races. The windings may form a plane which is generally parallel with a radial direction of the races. The receiver coil may have fewer windings or turns than the transmitter coil as described. The windings of the receiver coil may form a single layer in the radial direction. The windings of the receiver coil may have a radius which is less than a radius of windings of the transmitter coil. The windings of the receiver coil may be generally axially aligned with the windings of the transmitter coil. The windings of the receiver coil may have a lesser longitudinal span than the windings of the transmitter coil. The windings of the receiver coil may comprise multiple layers. The windings of the receiver coil may comprise a single layer in the radial direction. The windings of the receiver coil may have fewer layers than windings of the transmitter coil.

The receiver coil may be affixed to a longitudinal end surface of the inner race. The coil may be affixed to the longitudinal end surface via a support or holder. Windings of the coil may be embedded in the support.

The receiver support holder may take the form of a ring or cylinder. The windings of the receiver coil may be wrapped around an outer surface of the support or holder. The support may be at least partially hollow so as to minimise weight. The receiver support may be longitudinally aligned with the transmitter holder.

The receiver support may be affixed to an inner housing or flange. The receiver support may be affixed to the inner race. The inner housing or flange may be affixed to the inner race.

The receiver may further comprise a PCB. Receiver electronics may be affixed to the PCB. The PCB may be affixed to a longitudinal end surface of the inner race. The PCB may be positioned between the receiver coil and the longitudinal end surface of the inner race.

The PCB may be affixed to the inner housing or flange. The receiver PCB may be affixed to an end surface or outer face of the inner housing or flange. The receiver PCB may be positioned on an end surface of outer face of the inner housing or flange. The receiver PCB may be positioned in a cavity defined by the end surface of outer face of the inner housing or flange. The PCB may be covered with resin which is thermally conductive to dissipate heat. The resin may at least partially fill the cavity.

The transmitter and receiver supports or holders may be positioned between the outer and inner housings or flange. This may be reduce the likelihood of movement and accordingly misalignment between the transmitter and receiver coils.

The bearing may further comprise an end cap. The end cap may enclose the transmitter and receiver at a longitudinal end surface of the races. The end cap may cover the transmitter and/or receiver PCBs.

A drive shaft may pass through the inner housing or flange.

According to another aspect there is provided a motor comprising a drive shaft and any of the described bearings. The bearing may enclose or encircle the drive shaft. The motor may comprise an electric motor.

According to another aspect there is provided a transmitter affixed to or integrally formed with at least one bearing of an inner and outer race of a bearing, the races enclosing one or more roller elements, the transmitter comprising a coil mounted to a support axially adjacent the at least one race, the coil for generating a magnetic field for transferring electrical power.

The transmitter may comprise any of elements or features described in connection with the transmitter of the bearing.

According to another aspect there is provided a receiver affixed to or integrally formed with at least one bearing of an inner and outer race of a bearing, the races enclosing one or more roller elements, the receiver comprising a coil mounted to a support axially adjacent the at least one race, the coil for extracting electrical power from a generated magnetic field.

The receiver may comprise any of elements or features described in connection with the receiver of the bearing.

According to another aspect there is provided a wireless power transfer system comprising:
a transmitter affixed to or integrally formed with one of an inner and outer race of a bearing, the races enclosing one or more roller elements, the transmitter comprising a coil mounted to a support axially adjacent the at least one race of the bearing, the coil for generating a magnetic field for transferring electrical power; and
a receiver affixed to or integrally formed with another one of inner and outer race of the bearing, the receiver comprising a coil mounted to a support axially adjacent one of the bearing races, the coil of the receiver for extracting electrical power from the generated magnetic field.

According to another aspect there is provided a method of transferring electrical power wirelessly within a bearing comprising an inner race, an outer race and one or more roller elements positioned radially between the inner and outer races, the bearing further comprising a wireless power transfer system affixed to or integrally formed with at least one of the inner and outer races, the method comprising:
generating an electrical field, via a transmitter affixed to or integrally formed with one of the inner and outer races, to transfer electrical power to a receiver affixed to or integrally formed with the other one of the inner and outer races.

According to another aspect there is provided a method of transferring electrical power wirelessly within a bearing comprising an inner race, an outer race and one or more roller elements positioned radially between the inner and outer races, the bearing further comprising a wireless power transfer system affixed to or integrally formed with at least one of the inner and outer races, the method comprising:
extracting electrical power, via a receiver affixed to or integrally formed with one of the inner and outer races, from a magnetic field generated by a transmitter affixed to or integrally formed with another one of the inner and outer races.

According to another aspect there is provided a method of transferring electrical power wirelessly within a bearing comprising an inner race, an outer race and one or more roller elements positioned radially between the inner and outer races, the bearing further comprising a wireless power transfer system at least partially enclosed between the races, the method comprising:
extracting electrical power, via a receiver positioned proximate a longitudinal end surface of at least one of the races, from a magnetic field generated by a transmitter.

According to another aspect there is provided a controller adapted to perform any of the described methods. The controller may comprise a processor and/or computer-readable storage medium. The processor may be adapted to execute computer program code stored on the storage medium. The program code may be for executing one or more steps of the described method. The controller may control the transmitter and/or receiver.

According to another aspect there is provided a non-transitory computer-readable storage medium having program code stored therein, the program code when executed by a processor performing any of the described methods.

The described wireless power transfer system, transmitter or receiver may be a high frequency wireless power transfer, transmitter or receiver, respective, such as those described in applicant's U.S. Pat. No. 11,817,834, the relevant portions of which are incorporated herein by reference.

The described system, transmitter or receiver does not necessitate the use of ferrites which may be heavy and fragile. In other words, the transmitter and/or receiver, specifically, the transmitter coil and/or receiver coil may be ferriteless. In particular, the coils used in the system, transmitter and receiver may comprise windings. In contrast, conventional wireless power transfer systems may utilise ferrite coils. When used in a bearing, ferrite poses a high risk of system failure, reduced system reliability, and/or reduce system robustness. Ferrite is known to be fragile and may crack and/or break when subjected to forces from impact and vibration, such as those present in a bearing. Additionally, ferrite has a limited temperature range, and its properties are dependent on the environment.

Accordingly, the described system, transmitter or receiver which may remove ferrite in contrast with conventional wireless power transfers may be more robust and reliable than conventional systems. Additionally, the described aspects may remove failure points and provide a wireless power transfer system, transmitter or receiver which is better able to withstand high forces. Stripping ferrite from the coils may allow for operation at higher frequencies and therefore may allow higher Q factors. This may allow electrical power to be transferred across larger gaps and/or may relax requirements for precise coil alignment. Further, wireless power transfer efficiency may be improved over conventional wireless power transfer systems which include ferrite.

It should be understood that any features described in relation to one aspect, example or embodiment may also be used in relation to any other aspect, example or embodiment of the present disclosure. Other advantages of the present disclosure may become apparent to a person skilled in the art from the detailed description in association with the following drawings.

### BRIEF DESCRIPTION OF THE DRAWINGS

Embodiments will now be described more fully with reference to the accompanying drawings in which:

FIG. 1 is a block diagram of a wireless power transfer system;

FIG. 2 is another block diagram of a wireless power transfer system;

FIG. 3 is an exploded view of a wireless power transfer system in accordance with an aspect of the disclosure;

FIG. 4 is a partially exploded view of the system of FIG. 3;

FIG. 5 is a perspective view of the system of FIG. 3;

FIG. 6 is a cut away perspective view taken along a vertical central axis of the system of FIG. 3;

FIG. 7 is another perspective view of the system of FIG. 3;

FIG. 8 is a perspective view of another wireless power transfer system in accordance with an aspect of the disclosure;

FIG. 9 is a perspective view of another wireless power transfer system in accordance with an aspect of the disclosure;

FIG. 10 is a cut away perspective view taken along a vertical central axis of the system of FIG. 9;

FIG. 11 is another cut away perspective view taken along a vertical central axis of the system of FIG. 9 with a rotor;

FIG. 12 is a perspective view of another wireless power transfer system in accordance with an aspect of the disclosure;

FIG. 13 is a cut away perspective view taken along a vertical central axis of the system of FIG. 12;

FIG. 14 is another cut away perspective view taken along a vertical central axis of the system of FIG. 12 with a rotor;

FIG. 15 is a perspective view of another wireless power transfer system in accordance with an aspect of the disclosure;

FIG. 16 is a cut away perspective view taken along a vertical central axis of the system of FIG. 15;

FIGS. 17A and 17B are perspective views of portions of the wireless power transfer system of FIG. 15;

FIG. 18 is another cut away perspective view taken along a vertical central axis of the system of FIG. 15 with a rotor;

FIGS. 19A and 19B are perspective views of another wireless power transfer system in accordance with an aspect of the disclosure;

FIG. 20 a cut away perspective view taken along a vertical central axis of the system of FIGS. 19A and 19B; and

FIG. 21 is a perspective view of a portion the system of FIGS. 19A and 19B.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings. It will also be appreciated that like reference characters will be used to refer to like elements throughout the description and drawings.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the subject application that elements, components, and/or other subject matter that is described as being adapted to perform a particular function may additionally or alternatively be described as being configured to perform that function, and vice versa. Similarly, subject matter that is described as being configured to perform a particular function may additionally or alternatively be described as being operative to perform that function.

It will be understood that when an element is referred to as being “on,” “attached” to, “connected” to, “coupled” with, “contacting,” etc., another element, it can be directly on, attached to, connected to, coupled with, or contacting the other element or intervening elements may also be present.

It should be understood that use of the word “exemplary”, unless otherwise stated, means ‘by way of example’ or ‘one example’, rather than meaning a preferred or optimal design or implementation.

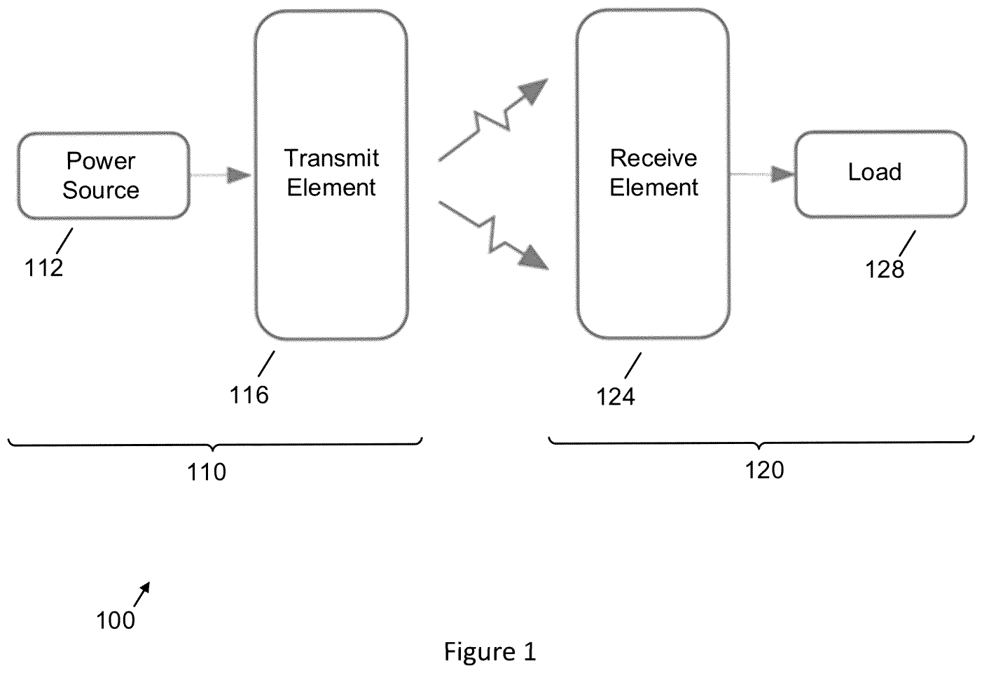

Turning now to FIG. 1, a wireless power transfer system generally identified by reference numeral 100 is shown. The wireless power transfer system 100 comprises a transmitter 110 comprising a power source 112 electrically connected to a transmit element 116, and a receiver 120 comprising a receive element 124 electrically connected to a load 128. Power is transferred from the power source 112 to the transmit element 116. The power is then transferred from the transmit element 116 to the receive element 124 via resonant or non-resonant electric or magnetic field coupling. The power is then transferred from the receive element 124 to the load 128. Exemplary wireless power transfer systems 100 include a high frequency inductive wireless power transfer system as described in applicant's U.S. Pat. No. 11,817,834 B2, or a resonant capacitively coupled wireless power transfer system as described in applicant's U.S. Pat. No. 9,653,948 B2, the relevant portions of which are incorporated herein by reference.

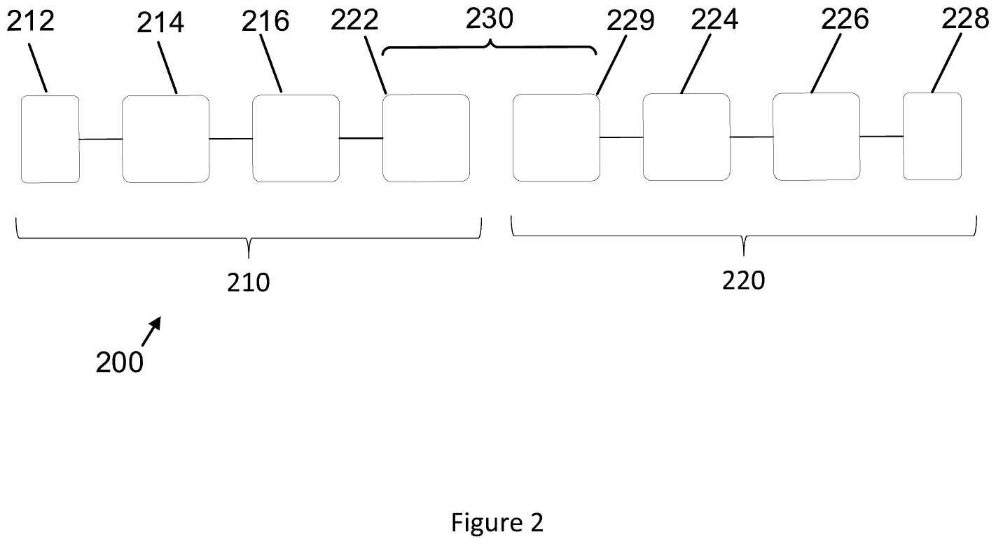

Turning now to FIG. 2, another embodiment of a wireless power transfer system is shown generally identified as reference numeral 200. The wireless power transfer system 200 comprises a power supply 212, DC/DC converter 214, circuitry 216, and transmitter element 222. The power supply 212 is electrically connected to the DC/DC converter 214. The DC/DC converter 214 is electrically connected to circuitry 216. The circuitry 216 is electrically connected to the transmitter element 222.

The power supply 212 is for generating an input power signal for transmission of power. In this embodiment, the input power signal is a direct current (DC) power signal.

The DC/DC converter 214 is for converting a received DC voltage signal to a desired voltage level. The received DC voltage may be from the power supply 212. The system 200 is illustrated as comprising the DC/DC converter 214, one of skill in the art will appreciate other configurations are possible. In another embodiment, no DC/DC converter is present.

In the illustrated arrangement, the circuitry 216 comprises an inverter and an output stage. The output stage matches the output impedance of the circuitry 216 to the optimum impedance of a wireless link 230 between the transmitter and receiver. The output stage also filters high frequency harmonic components of the inverter. As one of skill in the art will appreciate, the circuitry 216 may comprise only an inverter with no output stage being present. The DC/DC converter 214 and the inverter of the circuitry 216 may be integrated into a single unit. Examples of a combined DC/DC converter and inverter are described in applicant's U.S. Provisional Application No. 63/539,974, the relevant portions of which are incorporated herein by reference.

The transmitter element 222 comprises one or more inductive elements, i.e., inductors. The inductive elements may comprise one or more coils. The coils may include booster or shield coils such as described in applicant's U.S. patent application Ser. No. 17/193,539, the relevant portions of which are incorporated herein by reference.

In another arrangement, the transmitter element 222 comprise one or more capacitive elements, e.g., capacitive electrodes. The capacitive electrodes may be laterally spaced, elongate electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. As one of skill in the art will appreciate, the transmitter element 222 may comprise a combination of inductive and capacitive elements.

The power source 212 supplies a DC input power signal to the DC/DC converter 214 which converts the signal to a desired voltage level. The inverter of the circuitry 216 receives the converted DC power signal and inverts the converted DC power signal to generate a magnetic and/or electric field at the transceiver element 222 to transfer power via electric or magnetic field coupling. Specifically, the transmitter element 222 generates a magnetic/electric field to transfer power to the receiver via magnetic/electric field coupling. The power source 212, DC/DC converter 214, circuitry 216 and transmitter element 222 may collectively form a transmitter 210. As previously stated, the DC/DC converter 214 may not be present in the transmitter 210.

The wireless power transfer system 200 further comprises load 228, DC/DC converter 226, circuitry 224, and receiver element 229. The load 228 is electrically connected to the DC/DC converter 226. The DC/DC converter 226 is electrically connected to circuitry 224. The circuitry 224 is electrically connected to the receiver element 229.

In the illustrated arrangement, the load 228 is a DC load. The load 228 may be static or variable.

The DC/DC converter 226 is for converting a received DC voltage signal to a desired voltage level. The received DC voltage may be from the circuitry 224. While the system 200 comprises the DC/DC converter 226, one of skill in the art will appreciate other configurations are possible. In another embodiment, no DC/DC converter 226 is present.

The circuitry 224 comprises an input stage and a rectifier, e.g., diode rectifier or synchronous rectifier. The input stage is configured to ensure optimum impedance presented to the receiver element 229 at the full power state of the wireless power transfer system 200. The input stage may also preserve the quasi-voltage source behaviour of the receiver element 229 so the output of the synchronous rectifier exhibits a stable DC voltage from no load to full load conditions. As one of skill in the art will appreciate, the circuitry 224 may comprise only a rectifier with no input stage being present.

The receiver element 229 comprises one or more inductive elements, i.e., inductors. The receiver element 229 may comprise one or more coils. The coils may include booster or shield coils such as described in applicant's U.S. patent application Ser. No. 17/193,539, the relevant portions of which are incorporated herein by reference.

In another arrangement, the transmitter element 222 comprise one or more capacitive elements, e.g., capacitive electrodes. The capacitive electrodes may be laterally spaced, elongate electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. As one of skill in the art will appreciate, the transmitter element 222 may comprise a combination of inductive and capacitive elements.

The transmitter and receiver elements 222, 229 of the system 200 form the wireless link 230. The elements 222, 229 are separated by a wireless gap. The wireless gap may be formed by atmosphere, i.e. air, or by a physical medium, e.g., walls, glass, liquids, wood, insulations, etc. Liquid may be present in the wireless gap such as oil or lubricant. The liquid may be used for cooling components of the system 200. Power is transferred from one element to the other across the wireless link 230 via resonant or non-resonant magnetic and/or electric field coupling, i.e., electric or magnetic induction.

During operation, the receiver element 229 extracts power from a magnetic and/or electric field generated by the transmitter element 222. The circuitry 224 acts as a rectifier, e.g., diode rectifier or synchronous rectifier, and rectifies the received power signal. The DC/DC converter 226 converts the rectified power signal to the desired power level which is received by the load 228. In this way, the receiver element 229 extracts power transmitted by the transmitter element 222 (transmitter 210) such that electrical power is transferred to the load 228 via magnetic/electric field coupling. The load 228, DC/DC converter 226, circuitry 224 and receiver element 229 may collectively form a receiver 220. As previously stated, the DC/DC converter 226 may not be present in the receiver 220.

In magnetic field coupling, the inverter (DC/AC inverter) of the circuitry 216 of the transmitter 210 is configured to convert the DC power signal from the DC/DC converter 214 into a sinusoidal RF power signal. The sinusoidal RF power signal is output from the DC/AC converter to the transmitter element 222. In the case of magnetic field coupling, the transmitter element 222 comprises a coil, i.e., a plurality of windings forming at least one coil.

The DC/AC inverter of the circuitry 216 drives the transmitter coil with a sinusoidal alternating current (AC). The transmitter coil is configured to generate an inductive (magnetic) field and to transfer power via inductive (magnetic) field coupling. The DC/AC inverter takes a DC input voltage and converts it to an AC current to drive the transmitter coil.

The described wireless power transfer system may be used in a variety of applications. It may be desirable to transfer between rotating bodies, or between a rotating and non-rotating body. Conventional power transfer between stationary and rotating structures may involve the use of a slip ring. However, such slip rings may require maintenance, may be prone to wear. In particular, slip rings may be problematic in high temperature and high speed environments. Alternatives and/or improvements are desired.

A bearing may be used in rotating structures to reduce friction and provide support. For example, one or more bearings may be used to support the spinning shaft of an electric motor during operation.

A wireless power transfer system may be incorporated into a bearing to provide wireless power transfer between the two races of the bearing, i.e., the outer race and the inner race. Incorporating a wireless power transfer system into a bearing may remove the need for an additional power transfer mechanism, e.g., a slip ring and/or brushes. Further, a wireless power transfer system may not require the same frequency of maintenance and/or experience the same wear as a slip ring or brushes, such as on a brushed motor. As such, overall performance may be improved. Additionally, incorporating a wireless power transfer system into a bearing may reduce the harsh environmental forces (e.g., high heat and/or temperature) to which a slip ring or brushes may be exposed. This may improve performance and component longevity, while reducing maintenance and downtime. Additionally, as the wireless power transfer system is incorporated in the bearing, e.g., in a volume defined by the races, the system may be cooled by motor cooling fluid. This may reduce overheating of the system.

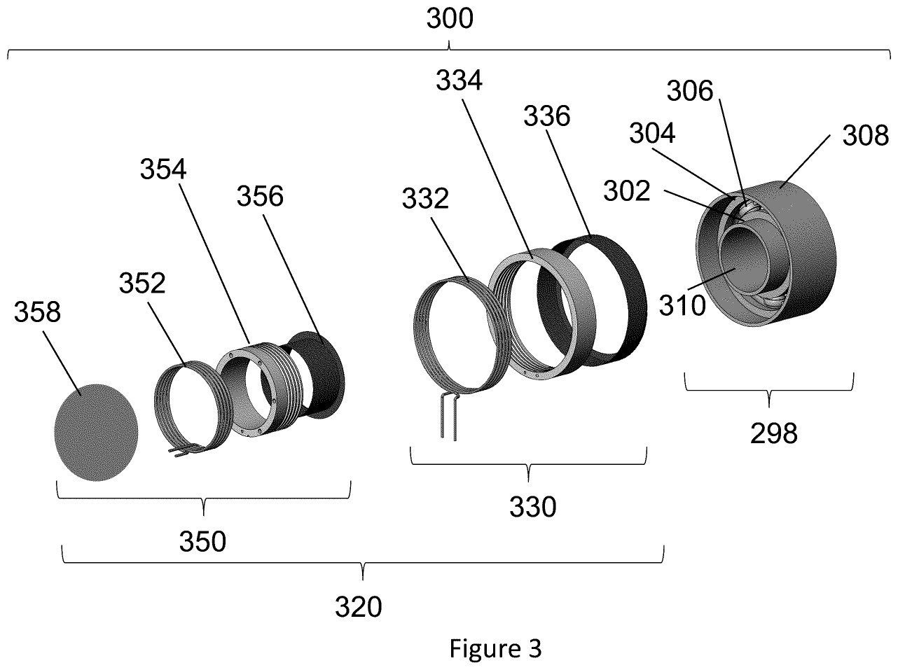

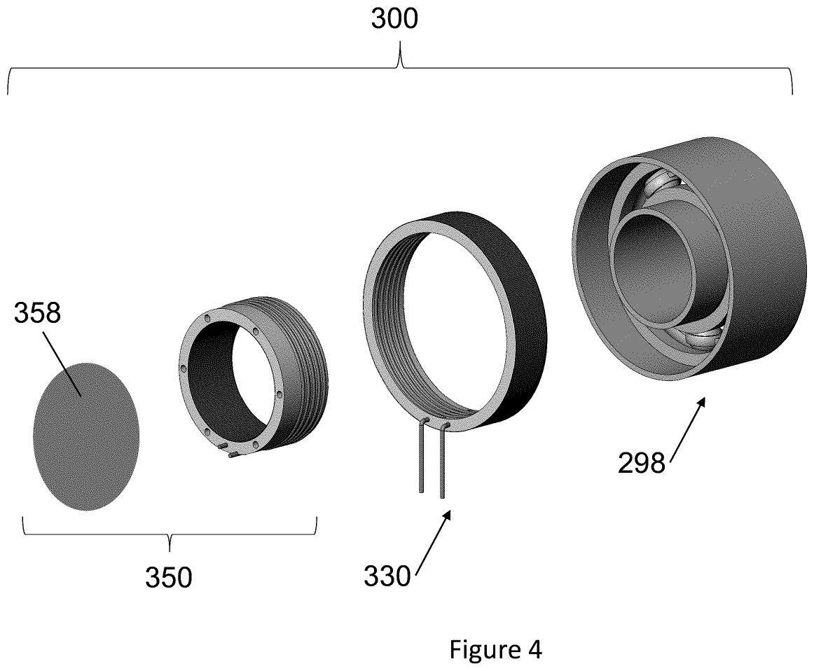

Turning now to FIGS. 3 and 4, a bearing 300 in accordance with an aspect of the disclosure is illustrated. The bearing 300 comprises a bearing assembly 298 comprising inner and outer races 302, 304 within which roller elements 306 are positioned. The races 302, 304 may have grooved inner surfaces within which the roller elements 306 rest. The inner race 302 may be free to rotate while the outer race 304 stays stationary. The bearing assembly 298 may further comprise an inner housing 310 and an outer housing 308. The inner housing 310 may be enclosed by the races 302, 304 while the outer housing 308 may enclose the races 302, 304 and the inner housing 310. The races 302, 304 and housings 308, 310 are generally hollow cylinders. The outer housing 308 has the largest radius, with the outer race 304, inner race 302, and inner housing 310 having progressively smaller radii. The inner housing 310 may define a central aperture through which a shaft 312 may pass. The shaft 312 may the drive shaft of an electrical motor as will be described. The inner race 302 rotates or spins with the shaft 312 with the roller elements 306 allowing the inner race 302 to spin.

The shaft 312 may be made of steel. The steel 312 may be external to the bearing 300. While not shown in the figures, the shaft 312 is shielded. Specifically, a shaft shield comprises copper tape wrapped around the circumference of the shaft 312 for at least a longitudinal portion of the shaft 312. The portion may be aligned with the inner race 302. The shaft shield may prevent penetration of a magnetic field into the shaft 312 which may negatively impact wireless power transfer efficiency.

While the inner race 302 is described as spinning or rotating while the outer race 304 is stationary, one of skill in the art will appreciate that the outer race 304 may spin or rotate while the inner race 302 may remain stationary, or both the races 302, 304 may spin or rotate. The races 302, 304 spin or rotate along their longitudinal axis. The races 302, 304 are radially collinear in that they share the same radial centre. Additionally, the outer and inner housings 308, 310 share the same radial centre as the races 302, 304.

The bearing 300 also comprises a wireless power transfer system for transferring electrical power from the non-rotating outer race 304 to the rotating inner race 302. The wireless power transfer system comprises a receiver 350 for receiving electrical power transferred via magnetic field coupling from a field generated by a transmitter 330.

The transmitter 330 is adapted to generate a magnetic field for transferring electrical power to the receiver 350 via magnetic field coupling. While not shown in the drawings, the transmitter 330 receives a power signal from a power source, e.g., power source 212. The transmitter 330 may comprise electronics such as DC/DC converter, inverter, etc. The DC/DC converter and the inverter may be integrated into a single unit. Examples of a combined DC/DC converter and inverter are described in applicant's U.S. patent application Ser. No. 18/891,690, the relevant portions of which are incorporated herein by reference.

The transmitter 330 comprises a transmitter shield 336, a transmitter support 334, and a transmitter coil 332. The transmitter support 334 holds the transmitter coil 332 in place. In this arrangement, the transmitter support 334 is plastic although other materials may be used. The transmitter support 334 is generally cylindrical and hollow. Similarly, the transmitter coil 332 and transmitter shield 336 are hollow and cylindrical.

The transmitter support 334 secures the transmitter coil 332 within the outer race 304. The transmitter support 334 ensures the transmitter coil 332 is stationary to promote alignment with the receiver coil 352, and to maximise power transfer to the receiver coil 352. In the illustrated arrangement, the transmitter support 334 is made of plastic and is a hollow cylinder although other configurations are possible.

The transmitter support 334 comprises rings affixed to a main cylindrical portion at opposite ends of the cylindrical portion. The windings of the transmitter coil 332 are wrapped around the outer cylindrical surface of the main cylindrical portion of the transmitter support 334. In this way, the transmitter coil 332 is proximate the inner surface or wall of the outer race 304. The transmitter support 334 is plastic to reduce power losses and possible induced eddy currents.

The transmitter shield 336 is made of copper tape, or aluminium. The transmitter shield 336 is adhered into an outer surface of the transmitter support 334. The transmitter shield 336 focuses the magnetic field generated by the transmitter coil 332 within the volume defined by the outer race 304.

The transmitter coil 332 comprises a plurality of windings. The windings are constructed using magnet wire, litz wire (twisted multi-strand wire), copper traces, or conductive metal electroplated substrates. The windings form a helical wrap within the transmitter support 334. The windings may form a single longitudinal layer in that each of the windings is radially parallel. The windings are embedded in the transmitter support 334. The windings are embedded or over moulded into the transmitter support 334.

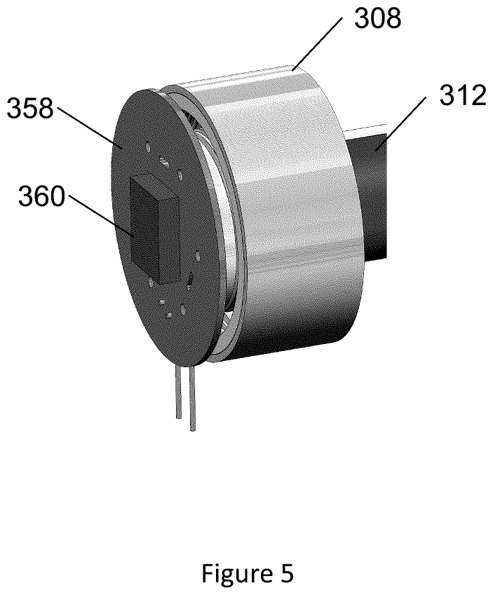

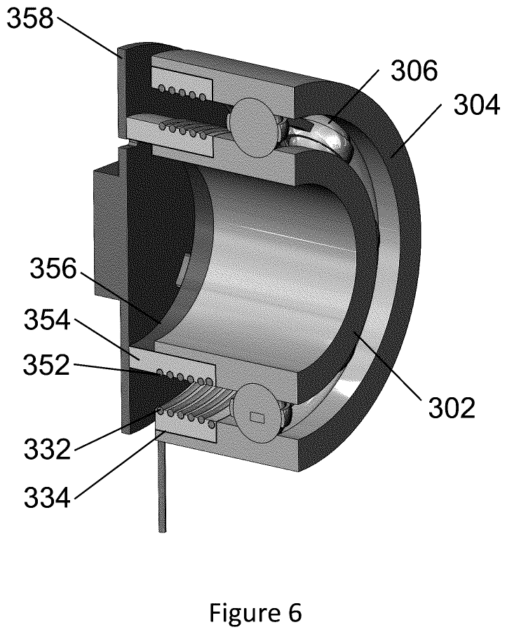

The transmitter shield 336 is proximate the outer race 304 with a smaller radius than the outer race 304. The transmitter support 334 is proximate the outer race 304 with a smaller radius than the outer race 304. The transmitter shield 336 is positioned between the outer race 304 and the transmitter support 334. The transmitter coil 332 is embedded within the transmitter support 334 with a smaller radius than the transmitter support 334. As shown in FIGS. 5 and 6, the transmitter shield 336, transmitter support 334, and transmitter coil 332 are embedded within the outer race 304.

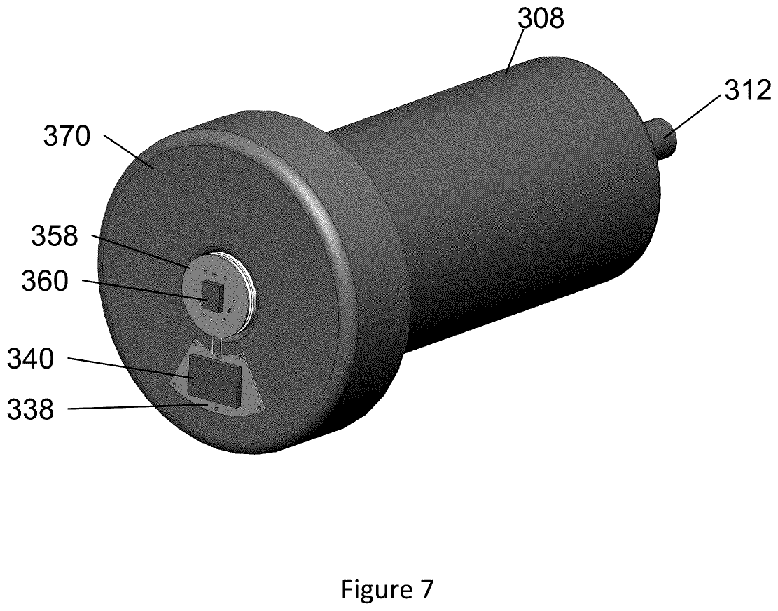

As shown in FIG. 7, the transmitter 330 further comprises a transmitter PCB 338 which has transmitter electronics 340 affixed thereto. The transmitter electronics 340 are electrically connected to the transmitter coil 332. In this arrangement, the transmitter electronics 340 comprise a DC/DC converter, inverter, and/or output stage. The DC/DC converter and the inverter may be integrated into a single unit. Examples of a combined DC/DC converter and inverter are described in applicant's U.S. patent application Ser. No. 18/891,690, the relevant portions of which are incorporated herein by reference.

The receiver 350 comprises a receiver shield 356, a receiver support 354, and a receiver coil 352. The receiver support 354 holds the receiver coil 352 in place. In this arrangement, the receiver support 354 is plastic although other materials may be used. The receiver support 354 is generally cylindrical and hollow. Similarly, the receiver coil 352 and transmitter shield 356 are hollow and cylindrical.

The receiver shield 356 is made of copper tape, or aluminium. The receiver shield 356 is adhered into an outer surface of the receiver support 354. The receiver shield 356 focuses the magnetic field extracted by the receiver coil 352 within the volume defined by the races 302, 304.

The receiver coil 352 comprises a plurality of windings. The windings are constructed using magnet wire, litz wire (twisted multi-strand wire), copper traces, or conductive metal electroplated substrates. The windings form a helical wrap within the receiver support 354. The windings may form a single longitudinal layer in that each of the windings is radially parallel. The windings are embedded in the receiver support 354. The windings are embedded or over moulded into the receiver support 354.

While particular configurations of the windings of the coils 332, 352 have been described, one of skill in the art will appreciate that variations are possible. For example, the windings may be wrapped on the transmitter support 334 and/or receiver support 354 to from multiple layers, e.g., a double layer transmitter coil 332 and/or a double layer receiver coil 352. The second layer may be wound on the first underlying layer. Additional layers may be wound on the second layer.

The receiver support 354 secures the receiver coil 352 to the inner race 302. The receiver support 354 ensures the receiver coil 352 is stationary during movement of the receiver 350 to promote alignment with the transmitter coil 330 in a longitudinal direction defined by the longitudinal axis of the races 302, 304, and to maximise power transfer from the transmitter coil 332. In the illustrated arrangement, the receiver support 354 is made of plastic and is a hollow cylinder although other configurations are possible. The windings of the receiver coil 352 are wrapped around the outer cylindrical surface of the receiver support 354.

The receiver shield 356 is proximate the inner race 302 with a larger radius than the inner race 302. The receiver support 354 is proximate the inner race 302 with a larger radius than the inner race 302. The receiver shield 356 is positioned between the inner race 302 and the receiver support 354. The receiver coil 352 is embedded within the receiver support 354 with a larger radius than the receiver support 354. As shown in FIGS. 5 and 6, the receiver shield 356, receiver support 354, and receiver coil 352 are embedded within the inner race 302.

The supports 334, 354 may comprise grooves or channels for the respective coils 332, 352. The windings of the coils 332, 352 may be positioned within the grooves to ensure precise positioning of the windings along the outer surface of the cylindrical portion of the supports 334, 354.

The supports 334, 354 may maximize power transfer efficiency and/or minimize variance by ensuring that the winding spacing and accordingly coil 332, 352 dimensions are accurate and reproducible.

The supports 334, 354 may be made of plastic to reduce power losses and possible induced eddy currents. Exemplary plastic includes Acrylonitrile butadiene styrene (ABS) or Nylon. In particular, ABS may exhibit lower power losses and/or reduced eddy currents than Nylon. Further, the supports 334, 354 may be made of Ultra-high-molecular-weight polyethylene (UHMWPE). UHMWPE may be useful when durability is desired. While plastic has been noted as the support material, one of skill in the art will recognize that other non-conductive materials may be used, such as ceramic. Additionally, the supports 334, 354 may also be reinforced with metal or other rigid materials.

Additionally, the central opening in the supports 334, 354 may reduce the amount of material needed for the supports 334, 354. This may further minimize losses and/or maximize power transfer efficiency.

The supports 334, 354 may be made of different materials as they may be subject to different environment. For example, the transmitter support 334 may need to be made of a tougher material and/or have a greater thickness than the receiver support 354.

While certain supports 334, 354 are described, one of skill in the art will appreciate, other supports may be used, or the supports may be eliminated altogether. Further, the coils 332, 352 may be affixed to their respective support surfaces via adhesives or other affixing means to promote respective alignment.

As shown in FIGS. 5 to 7, the transmitter 330 further comprises a transmitter PCB 338 which has transmitter electronics 340 affixed thereto, and the receiver 350 comprises electronics 360 for processing wirelessly extracted electrical power. The transmitter electronics 340 are electrically connected to the transmitter coil 332. In this arrangement, the transmitter electronics 340 DC/DC converter, inverter, and/or output stage. The DC/DC converter and the inverter may be integrated into a single unit. Examples of a combined DC/DC converter and inverter are described in applicant's U.S. Provisional Application No. 63/539,974, the relevant portions of which are incorporated herein by reference.

The receiver electronics 360 include a rectifier, and DC/DC converter. The rectifier may comprise applicant's own synchronous rectifier described in U.S. Pat. No. 11,637,453 B2, the relevant portions of which are incorporated herein by reference. The receiver 350 also comprises a PCB 358 which has the receiver electronics 360 affixed thereto.

In the illustrated arrangement, the transmitter PCB 338 is affixed to an end cap 370. The end cap 370 is affixed to the longitudinal ends of the bearing races 302, 304. The end cap 370 is generally perpendicular to the longitudinal axis of the races 302, 304. The end cap 370 enclose a volume defined between the races 302, 304. The PCB 338 is affixed to an outer surface of the end cap 370. As shown in FIG. 7, the end cap 370 has a central aperture through which the receiver PCB 358 passes.

The transmitter and receiver electronics 340, 360 may comprise one or more capacitors electrically connected to the respective coils 332, 352 such that the transmitter and receiver coils 332, 352 are resonant at a resonant frequency.

In the illustrated arrangement, the electronics 340, 360 are embedded in a heat dissipating material. In the case of the receiver electronics 360, the material forms a solid puck on the receiver PCB 358. The puck has embedded therein the electronics. The puck may dissipate heat out of the components of the receiver electronics 360. The puck may disperse heat through the puck material.

In the illustrated arrangement, inductors are not embedded in the puck material. Inductors may be too large to be embedded in the puck material. Instead, openings in the puck material allow for inductor connections and mounting. Alternatively, inductors of the receiver electronics 360 are low profile and/or embedded, even partially, in the puck material.

During operation power is transferred to the transmitter coil 332 which generated a magnetic field within the volume defined by the races 302, 304. The shields 336, 356 focus the magnetic field towards the receiver coil 352. The receiver coil 352 extracts electrical power from the generated power. In manner power is transferred from the stationary outer race 302 to the rotating inner race 304. As shown in FIG. 7, power may be transferred to the shaft 312 which is positioned within an aperture in the inner housing 310. In use, the shaft 312 and inner race 302 including the receiver 350 may be rotating at up to 20,000 rpm.

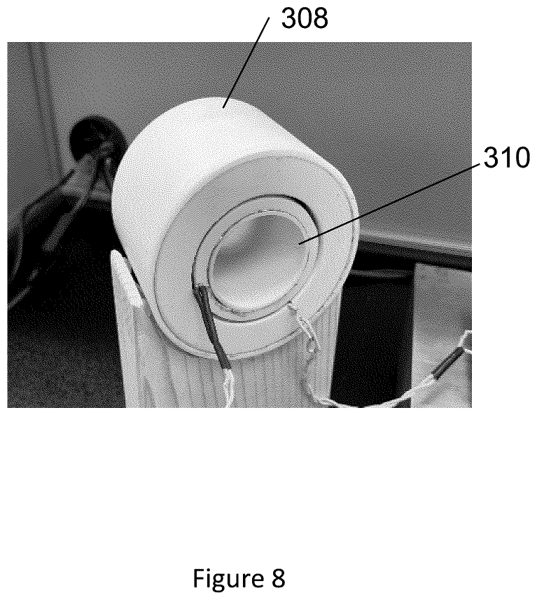

An experimental bearing 300 was constructed and tested in order to ascertain performance characteristics of the wireless power transfer system 320. The experimental bearing 300 is illustrated in FIG. 8. The outer and inner housing 308, 310 are shown in FIG. 8. In this experimental arrangement, the bearing assembly 298 was printed via additive manufacturing out of Rigid 10K material. Thus, in the experimental bearing 300, the bearing races 302, 304 are non-metal.

The bearing assembly 298 is 80 mm in diameter with a 35 mm inner diameter, i.e., the diameter of the inner housing 310. The entire bearing 300 is approximately 50 mm thick. The wireless power transfer system 320 is approximately 30 mm of the overall thickness. The coils 332, 352 each have 15 turns of 17 gauge 645 Litz wire. The transmitter coil 332 is 50 mm in diameter with its turns separated by 1 mm. The receiver coil 352 is 47.5 mm in diameter with its turns equally separated by 1 mm. The difference in transmitter coil 332 to receiver coil 352 diameter form the transfer distance of 1.5 mm.

Table 1 below shows the characteristics of each coil 332, 352 both coupled and uncoupled.

TABLE 1
Coil characteristics

| | Coupled | Uncoupled |
|---|---|---|
| Transmitter Inductance (uH) | 10.9 | 11 |
| Transmitter Quality Factor | 150 | 229 |
| Receiver Inductance (uH) | 9.2 | 9.36 |
| Receiver Quality Factor | 113 | 118 |
| Coupling Factor or Coefficient k | 0.835 | N/A |

As shown in Table 1, the coupling factor or coefficient is above 80% showing a high degree of power transfer from the transmitter 330 to the receiver 350.

While a particular configuration of the bearing 300 has been illustrated and described, one of the skill in the art will appreciate other configurations are possible. For example, the transmitter 330 is embedded in the outer race 304, and the receiver 350 is embedded in the inner race 302 in the arrangement illustrated in FIGS. 3-7; however, one of skill in the art will appreciate other configurations are possible.

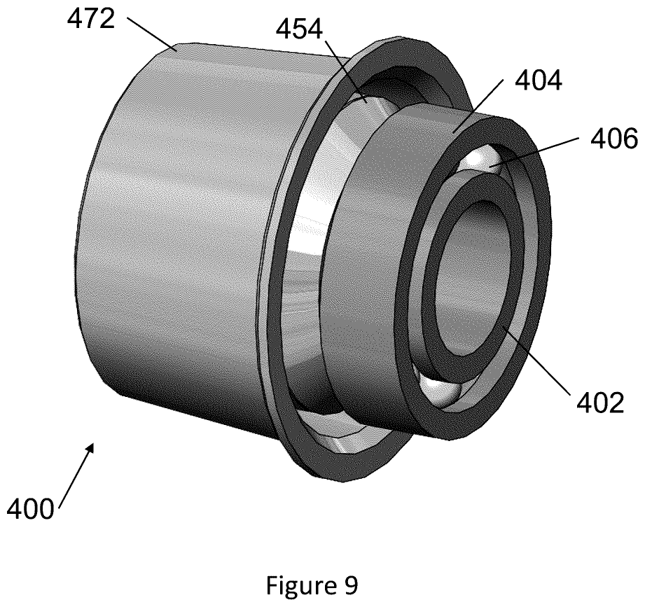

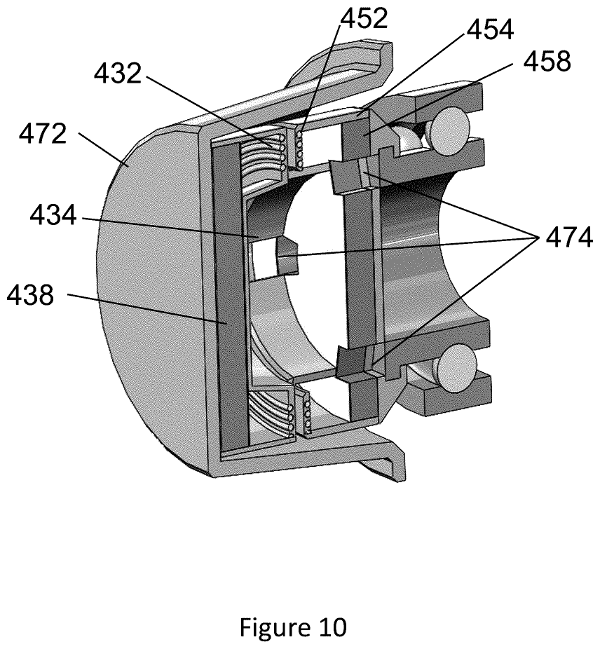

Turning now to FIGS. 9-11, another arrangement of a bearing 400 is illustrated. The bearing 400 comprises the same elements as the bearing 300 unless otherwise stated. Reference numerals for like features are incremented by “100”.

In this arrangement, the transmitter 430 and receiver 450, or at least portions thereof, are positioned within a second end cap 472. The second end cap 472 encloses the transmitter 430 and receiver 450. The inner surface of the second end cap 472 may be lined with a shield, such as the previously described transmitter and receiver shields 336, 356, to contain and/or focus the magnetic field generated by the transmitter 430.

In this arrangement, the receiver support 454 is affixed to the inner race 402. The support 454 is affixed to a longitudinal end surface of the inner race 402. The receiver PCB 458 is positioned within the support between the end surface and the receiver coil 452. The windings of the receiver coil 452 form a plane which is parallel with the longitudinal end surface of the inner race 402. The plane is perpendicular with the longitudinal axis of the inner race 402. Axially adjacent the receiver coil 452 is the transmitter coil 432. Similar to the receiver coil 452, windings of the transmitter coil 432 form a plane which is parallel with the longitudinal end surface of the inner race 402. Further, the plane formed by the transmitter coil 432 is perpendicular with the longitudinal axis of the inner race 402. The planes formed by the coils 432, 452 are parallel such that the coils 432, 452 are separated by a separation distance. The transmitter support 434 encloses the transmitter PCB 438 on which transmitter electronics (not shown) are mounted).

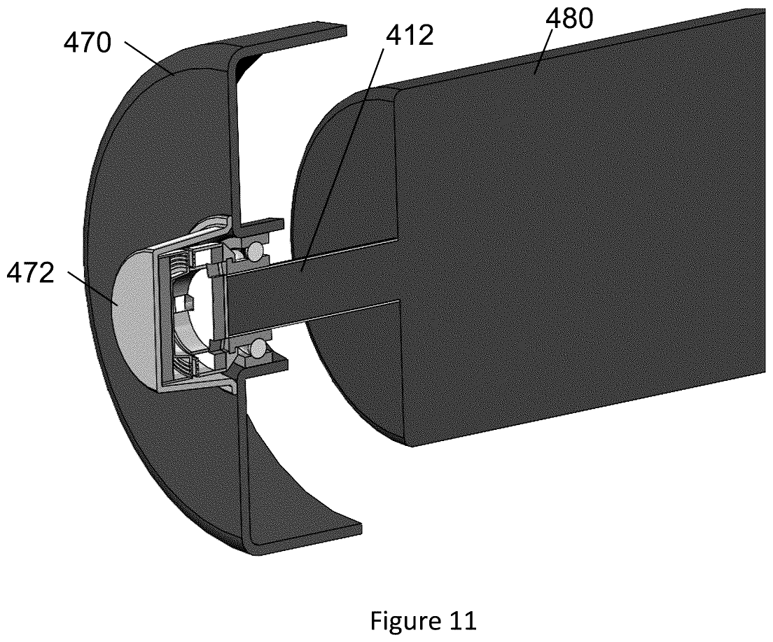

In the illustrated arrangement, the receiver support 454 and receiver PCB 458 comprise one or more aligned apertures 474. The apertures 474 facilitate the assembly of the receiver 450 and transmitter 430 on the shaft 412 of a rotor of a motor 480, e.g., an electric motor, as shown in FIG. 11. The apertures 474 provide access to the inner race 402.

In the illustrate arrangement, four apertures 474 are present although one of skill in the art will appreciate that more or less may be present. The four apertures 474 are evenly distributed along the receiver support 454 and receiver PCB 458.

The second end cap 472 is affixed to the end cap 470 as shown in FIG. 11. The inner race encircles the shaft 412 which is connected to a rotor 480 of a motor. The shaft 412 may rotate as a result of motor operation.

During operation, the receiver support 454, receiver PCB 458, receiver electronics mounted on the receiver PCB 458 (not shown), and the receiver coil 452 rotate as the inner race 402 rotates while the transmitter support 434, transmitter PCB 438, transmitter electronics mounted on the transmitter PCB 438 (not shown), and the transmitter coil 432 remain stationary. Electrical power may be transferred from the transmitter 430 to the receiver 450 which is rotating via the shaft 412.

While particular configurations of the bearing 300, 400 have been illustrated and described, one of the skill in the art will appreciate other configurations are possible.

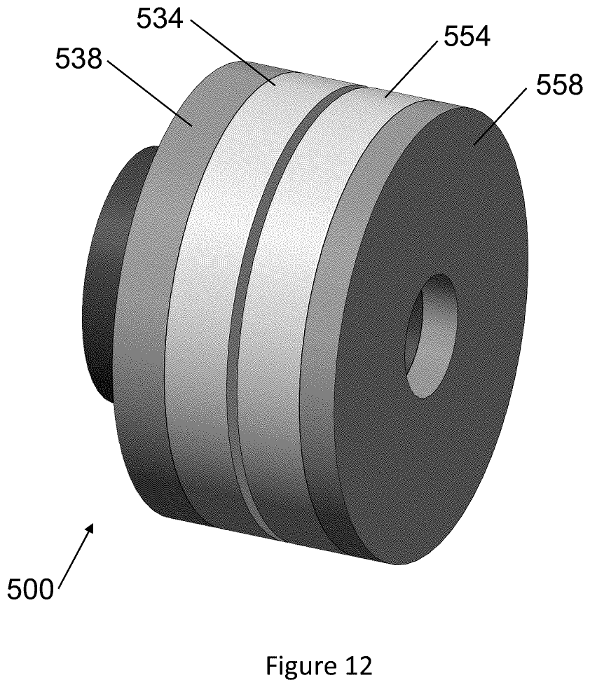

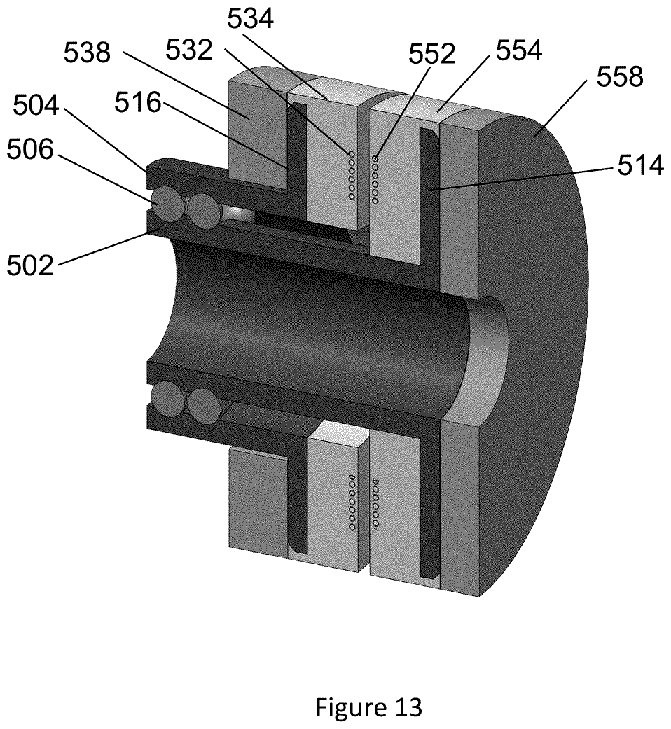

Turning now to FIGS. 12-14, another arrangement of a bearing 500 is illustrated. The bearing 500 comprises the same elements as the bearing 300 unless otherwise stated. Reference numerals for like features are incremented by “200”.

In this arrangement, the bearing arrangement 498 comprises two sets of roller elements 506 between inner and outer races 502, 504. Further, in this arrangement, the inner race 502 and the outer race 504 are generally cylindrical and hollow. The races 502, 504 extend in a longitudinal direction. At one longitudinal end of the races, each of the races 502, 504 comprises a perpendicular portion which extends perpendicular to the longitudinal axis of the races 502, 504. Specifically, the inner race 502 comprises an inner radial extension 514. The outer race 504 comprises an outer radial extension 516.

The inner radial extension 514 extends from a longitudinal end surface of the inner race 502 at an end of the inner race 502 opposite a rotor 580 of a motor to which a shaft 512 passing through the hollow inner race 502 is connected. The inner radial extension 514 extends in the radial direction and is generally perpendicular to the longitudinal axis of the inner race 502. The inner radial extension 514 forms a ring around the inner race 502. The outer radial extension 516 extends from a longitudinal end surface of the outer race 504 at an end of the outer race 504 opposite the rotor 580. The outer radial extension 516 extends in the radial direction and is generally perpendicular to the longitudinal axis of the outer race 504. The outer radial extension 516 forms a ring around the outer race 504.

The radial extensions 514, 516 are parallel to each other. The radial extensions 514, 516 define a volume therebetween. Within the volume, the transmitter support 534 and receiver support 554 are positioned. The transmitter coil 532 is embedded in the transmitter support 534, and the receiver coil 552 is embedded in the receiver support 554. The transmitter support 534 is affixed to an inner surface of the outer radial extension 516. The transmitter PCB 538 is affixed to an outer surface of the outer radial extension 516. The receiver support 554 is affixed to an inner surface of the inner radial extension 514. The receiver PCB 558 is affixed to an outer surface of the inner radial extension 514. Shields, e.g., the transmitter and receiver shields 536, 556 may be positioned between the supports 534, 554 and the inner surfaces of the extensions 514, 516. In particular, the inner surfaces of the extension 514, 516 may be lined with the shields 536, 556.

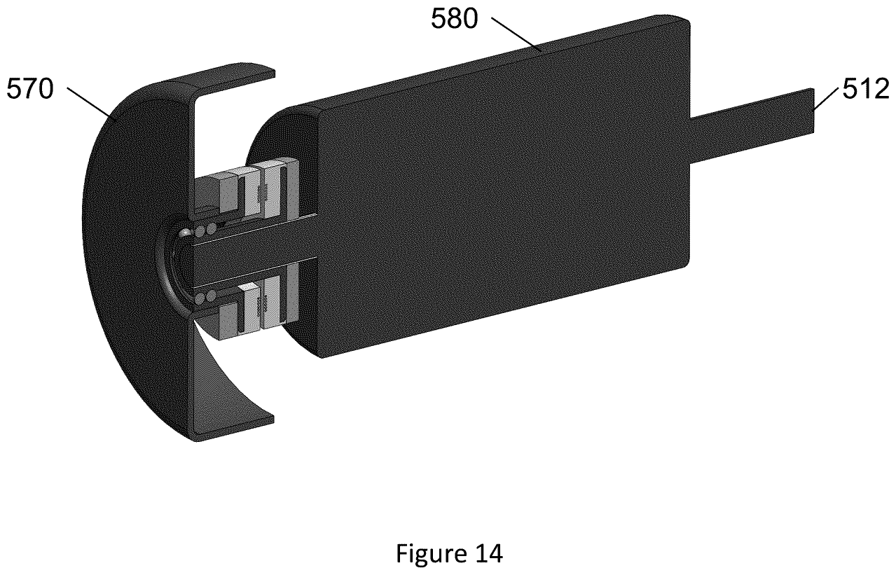

The windings of the receiver coil 552 form a plane which is perpendicular with the longitudinal axis of the inner race 502. The plane is perpendicular with the longitudinal axis of the inner race 502. Axially adjacent the receiver coil 552 is the transmitter coil 532 separated by a transmission distance. Similar to the receiver coil 552, windings of the transmitter coil 532 form a plane which is perpendicular with the longitudinal axis of the outer race 504. Further, the plane formed by the transmitter coil 532 is perpendicular with the longitudinal axis of the outer race 502. The planes formed by the coils 532, 552 are parallel such that the coils 532, 552 are separated by a separation distance. Each PCB 538, 558 is in the shape of a ring with a central aperture. As shown in FIG. 14, the outer race 504 is fitted into a central aperture in the end cap 570. The end cap 570 encloses the PCBs 538, 558; supports 534, 554; and coils 532, 552. The shaft 512 passes through the inner race 502 and extends to the rotor 580. The PCBs 538, 558; supports 534, 554; and coils 532, 552 are positioned between the end cap 570 and the rotor 580.

While particular configurations of the bearing 300, 400, 500 have been illustrated and described, one of the skill in the art will appreciate other configurations are possible.

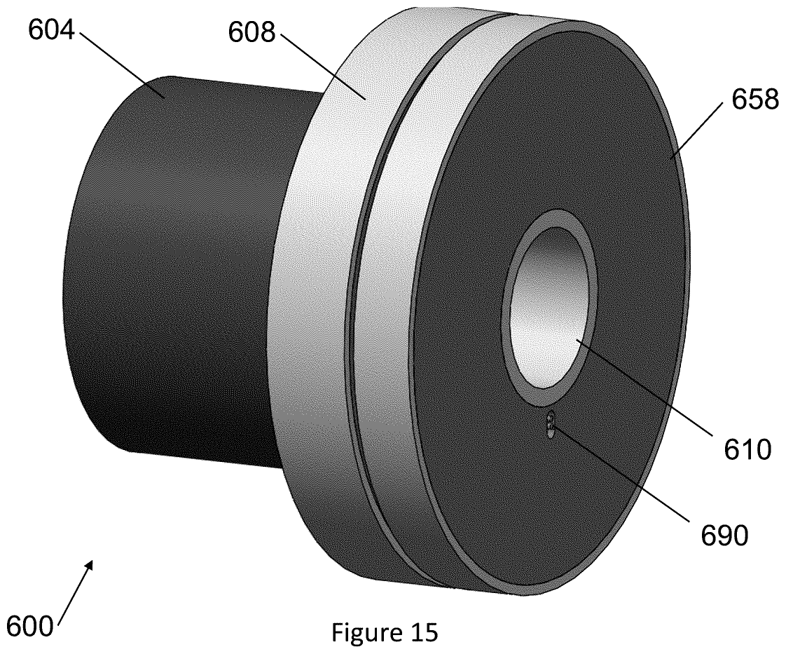

Turning now to FIGS. 15-17, another arrangement of a bearing 600 is illustrated. The bearing 600 comprises the same elements as the bearing 300 unless otherwise stated. Reference numerals for like features are incremented by “300”.

The arrangement illustrated in FIGS. 15-17 is a combination of the arrangement illustrated in FIG. 3-7 and the arrangement illustrated in FIGS. 12-14.

The transmitter 630 is embedded in the outer race 604, and the receiver 650 is embedded in the inner race 602 as is the case in the arrangement illustrated in FIGS. 3-7. In particular, the receiver support 654 with the windings of the receiver coil 652 in the receiver support 654 is embedded in the inner race 602. The transmitter support 634 with the windings of the transmitter coil 632 in the transmitter support 634 is embedded in the outer race 604. Thus, the supports 634, 654 and coils 632, 652 forms planes which are parallel to the planes formed by the races 602, 604.

However, in the arrangement illustrated in FIGS. 15-18, the PCBs 638, 658 are similar to the described PCBs 538, 558. The transmitter PCB 638 defines a plane which is generally perpendicular with the plane defined by the transmitter support 634 and coil 632. Further, the transmitter PCB 638 takes the forms a ring with a central aperture. The aperture is sized to supports 634, 654 and inner housing 610. The transmitter PCB 638 circumscribes a portion of the transmitter support 634. The transmitter PCB 638 is in contact with a surface of the transmitter support 634.

Further, the outer housing 608 encloses the transmitter support 634 and transmitter PCB 638. Thus, the outer housing 608 has a generically cylindrical shape along a first portion which is in contact with the transmitter support 634 with transmitter shielding 636 (not shown) between the outer housing 608 and transmitter support 634. The outer housing 608 has a second portion which is perpendicular to the first portion and is contact with the transmitter PCB 638. The second portion extends from an end of the first portion. A final third portion of the outer housing 608 extends from an end of the second portion and is generally parallel with the first portion. The third portion is also in contact with the transmitter PCB 638. Thus, the outer housing 608 encloses the transmitter support 634 within the outer race 604. The outer housing 608 also encloses the transmitter PCB 638 outside of the outer race 604.

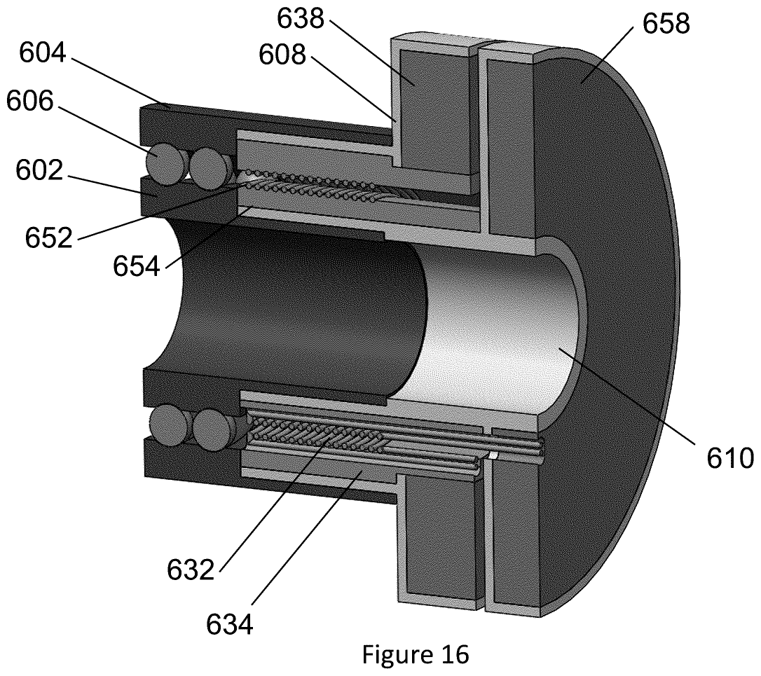

The receiver PCB 658 defines a plane which is generally perpendicular with the plane defined by the receiver support 654 and receiver coil 652. Further, the receiver PCB 658 takes the forms a ring with a central aperture. The aperture is sized to receive the inner housing 610. The inner housing 610 is a generally hollow cylinder with a radius smaller than the receiver support 654. The receiver PCB 658 circumscribes a portion of the inner housing 610. The receiver PCB 658 may also be enclosed by a second portion of the inner housing 610 which is in contact with a surface of the receiver PCB 658. As shown in FIGS. 15 and 16, the receiver PCB 658 includes a connection aperture 690 through which windings of the receiver coil 652 may pass for electrical connection to receiver electronics 660 (now shown) mounted on the receiver PCB 658.

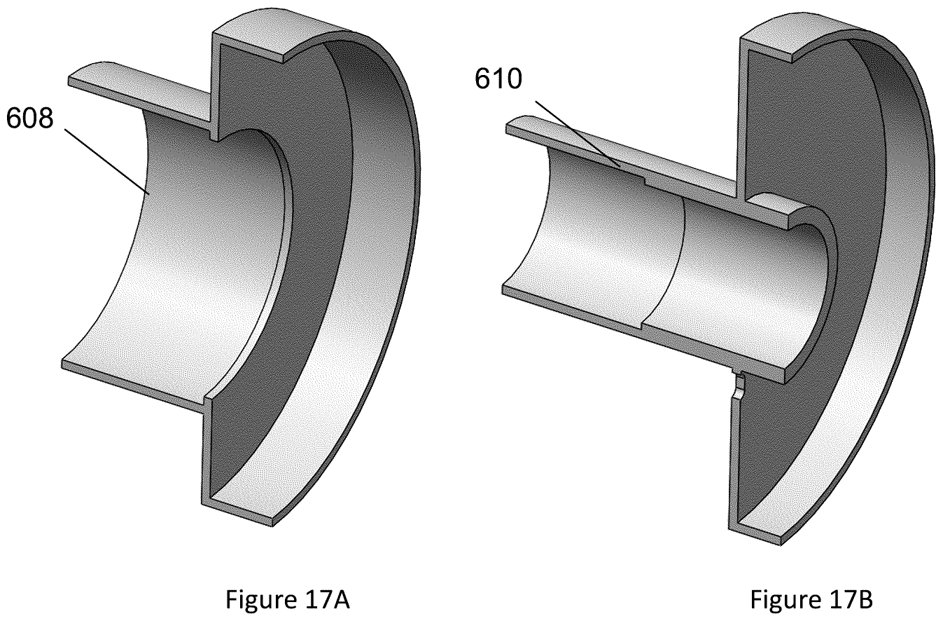

The housings 608, 610 are shown in greater detail in FIGS. 17A and 17B. The housings 608, 610 provide support to the PCBs 638, 658 and supports 634, 654.

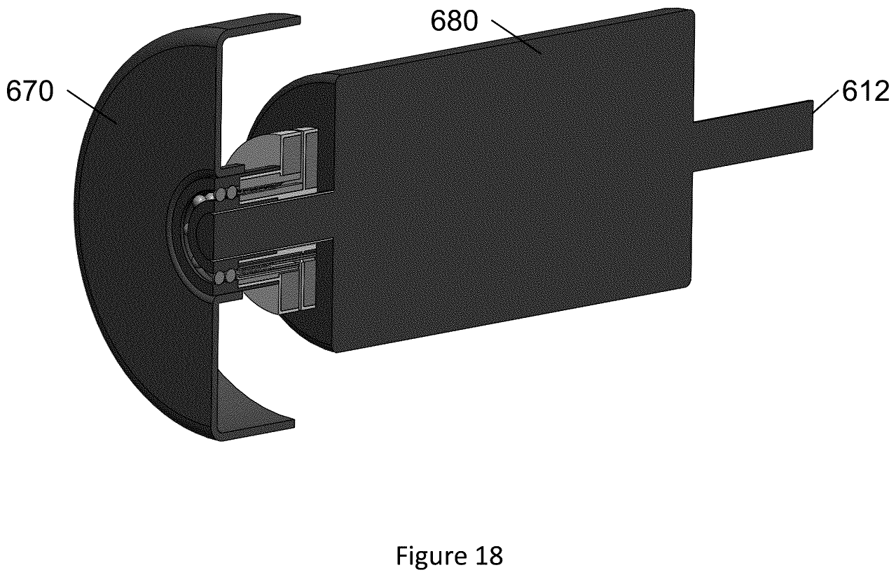

As illustrated in FIG. 18, the end cap 670 may be affixed to the bearing assembly 598 on one longitudinal end of the bearing assembly 598 while the wireless power transfer system 620 is affixed to the other longitudinal end. The shaft 612 may pass through the inner housing 610 and inner race 602 and be connected to a rotor 680 of a motor which is longitudinally adjacent the system 620. That is, the system 620 may be positioned between the rotor 680 and the bearing assembly 598.

During operation, the receiver PCB 658, inner housing 610, inner race 602, receiver support 654, and receiver coil 652 may be rotating relative to the stationary transmitter PCB 638, outer housing 608, outer race 602, transmitter support 634, and transmitter coil 632. Alternatively, both may be rotating, or the transmitter 630 and associated components may be rotating while the receiver 650 and associated components are stationary.

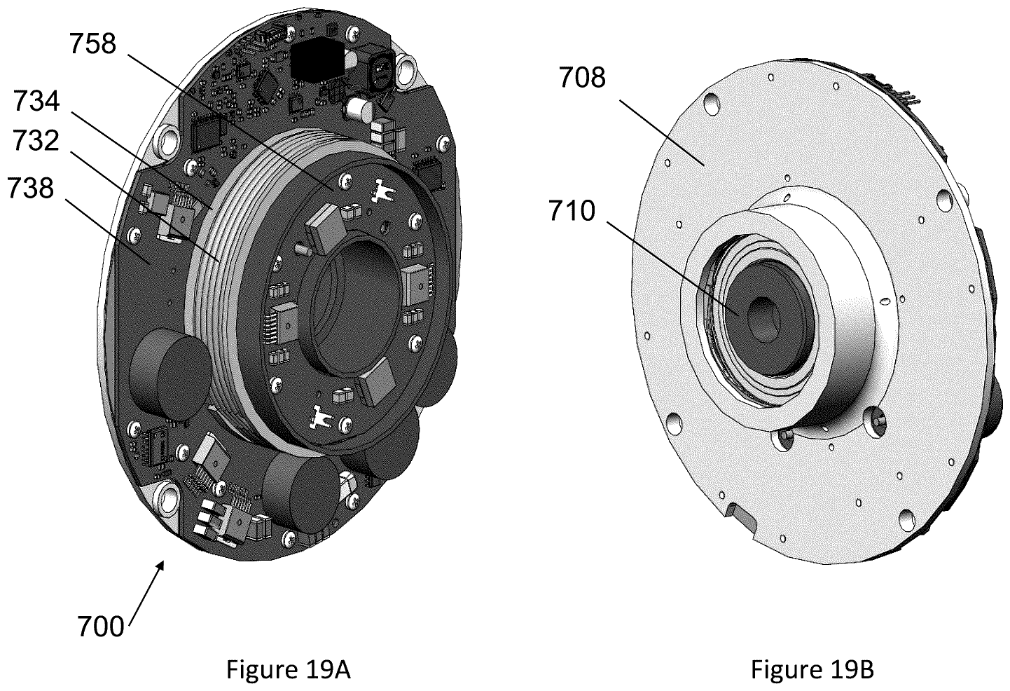

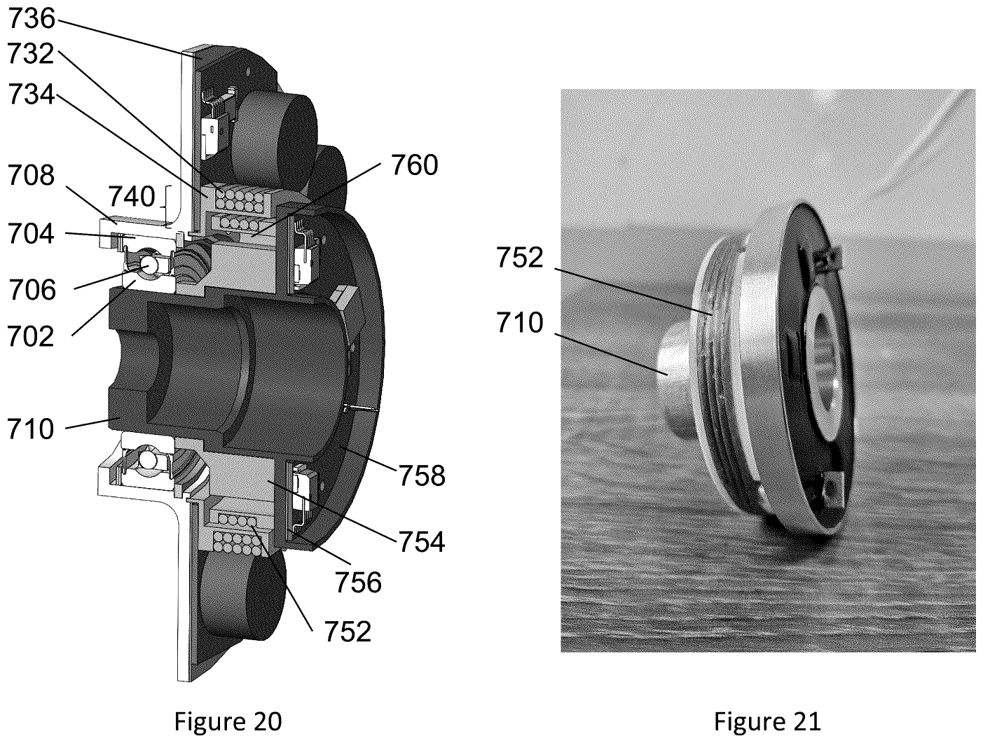

Turning now to FIGS. 19A, 19B and 20, another arrangement of a bearing 700 is illustrated. The bearing 700 comprises the same elements as the bearing 300 unless otherwise stated. Reference numerals for like features are incremented by “400”.

The bearing 700 comprises a bearing assembly comprising inner and outer races 702, 704 within which roller elements 706 are positioned. The races 702, 704 may have grooved inner surfaces within which the roller elements 706 rest. The inner race 702 may be free to rotate while the outer race 704 stays stationary. The bearing assembly may further comprise an inner housing 710 and an outer housing 708. The inner housing 710 may be enclosed by the races 702, 704 while the outer housing 708 may enclose the races 702, 704 and the inner housing 710.

The races 702, 704 are generally hollow cylinders. The outer housing 708 is an outer flange while the inner housing 710 is an inner flange. The outer housing 708 has the largest radius, with the outer race 704, inner race 702, and inner housing 710 having progressively smaller radii. The inner housing 710 may define a central aperture through which a shaft may pass. The shaft may the drive shaft of an electrical motor as described. The inner race 702 rotates or spins with the shaft with the roller elements 706 allowing the inner race 702 to spin.

While the inner race 702 is described as spinning or rotating while the outer race 704 is stationary, one of skill in the art will appreciate that the outer race 704 may spin or rotate while the inner race 702 may remain stationary, or both the races 702, 704 may spin or rotate. The races 702, 704 spin or rotate along their longitudinal axis. The races 702, 704 are radially collinear in that they share the same radial centre. Additionally, the outer and inner housings 708, 710 share the same radial centre as the races 702, 704.

While not shown in these drawings, an outer casing may be positioned over the bearing, specifically over the outer and inner housing or flanges 708, 710 to provide mechanical support and protection of the components.

The bearing 700 also comprises a wireless power transfer system for transferring electrical power from the non-rotating outer race 704 to the rotating inner race 702. The wireless power transfer system comprises a receiver for receiving electrical power transferred via magnetic field coupling from a field generated by a transmitter.

The transmitter is adapted to generate a magnetic field for transferring electrical power to the receiver via magnetic field coupling. While not shown in the drawings, the transmitter receives a power signal from a power source, e.g., power source 212. The transmitter may comprise electronics such as DC/DC converter, inverter, etc. The DC/DC converter and the inverter may be integrated into a single unit. Examples of a combined DC/DC converter and inverter are described in applicant's U.S. patent application Ser. No. 18/891,690, the relevant portions of which are incorporated herein by reference.

The transmitter comprises a transmitter thermal pad 736, a transmitter support or holder 734, and a transmitter coil 732 having a plurality of windings, e.g., 10 windings or turns. The transmitter support 734 holds the transmitter coil 732 in place. In this arrangement, the transmitter support 734 is plastic although other materials may be used. The transmitter support 734 takes the form of a ring or hollow cylinder. The transmitter coil 732 are wound or positioned on an outer surface of the transmitter support 734.

In this arrangement, the transmitter further comprises a transmitter shield 740, although one of skill in the art will appreciate this may be omitted. The transmitter shield 740 takes the forms of a copper plate within the transmitter PCB 738 at the location highlighted in FIG. 20. The transmitter shield 740 may alternatively be made of copper tape, or aluminium. The transmitter shield 740 focuses the magnetic field generated by the transmitter coil 732 towards a receiver coil 752 of the receiver, and ensures the field does impact electronics outside the outer housing 708.

The transmitter support 734 secures the transmitter coil 732 to the outer race 704. The transmitter support 734 ensures the transmitter coil 732 is axially aligned with a corresponding receiver coil 752 of the receiver to maximize power transfer to the receiver. In the illustrated arrangement, the transmitter support 734 is made of plastic and is a hollow cylinder although other configurations are possible.

The transmitter support 734 comprises a main cylindrical portion having a laterally extending portion affixed to the outer race 704 of the bearing 700. The transmitter support 734 is plastic to reduce power losses and possible induced eddy currents.

The transmitter thermal pad 736 facilitates heat flow from the transmitter PCB 738 to prevent overheating. The transmitter thermal pad 736 is adhered into an inner surface of the outer housing or flange 708. The transmitter thermal pad 736 is positioned between the transmitter PCB 738 and the outer housing 708. The transmitter is more generally between the transmitter coil 732 and the outer housing 708.

The transmitter coil 732 comprises a plurality of windings. The windings are constructed using magnet wire, litz wire (twisted multi-strand wire), copper traces, or conductive metal electroplated substrates. The windings form multiple (e.g., 2) layers on an outer surface of the transmitter support or holder 734. Each layer is radially parallel. The number of windings is selected such that a span of the windings is greater than a span of the windings of the receiver coil 752. In this way, the field generated by the transmitter coil 732 envelops the receiver coil 752 and power transfer via field coupling is maximised. The windings are embedded in the transmitter support 734. The windings may be embedded or over moulded into the transmitter support 734.

The transmitter further comprises a transmitter PCB 738 which has transmitter electronics affixed thereto. The transmitter electronics are electrically connected to the transmitter coil 732. In this arrangement, the transmitter electronics may comprise DC/DC converter, inverter, and/or output stage. The DC/DC converter and the inverter may be integrated into a single unit. Examples of a combined DC/DC converter and inverter are described in applicant's U.S. patent application Ser. No. 18/891,690, the relevant portions of which are incorporated herein by reference. The transmitter PCB 738 is mounted to an inner surface of the outer housing or flange 708. The transmitter thermal pad 736 is positioned between the outer housing 708 and the PCB 738.

The receiver comprises a receiver thermal pad 756, a receiver support or holder 754, and a receiver coil 752. The receiver support 754 holds the receiver coil 752 in place. In this arrangement, the receiver support 754 is plastic although other materials may be used. The receiver support 754 takes the forms a ring or cylinder which is hollow. As illustrated in FIG. 20, the receiver support 754 includes a recess 760. The recess 760 reduces the weight of the receiver support 754 so as reduce the likelihood of vibration which could negatively impact power transfer and mechanical stability, especially during rotation of one or more of the races 702, 704. One of skill in the art will appreciate that the recess may be omitted.

The receiver support 754 has a generally cylindrical portion and a laterally extending portion. The cylindrical portion is affixed to the inner housing or flange 710. The laterally extending portion is affixed to the inner race 706. During rotation of the inner race, the receiver support 754 and thus the receiver coil 752 wound around the support 754 are similarly rotated.

The receiver thermal pad 756 for assisting with heat dissipation. One of skill in the art will appreciate the thermal pad 756 may be omitted. The receiver thermal pad 756 is positioned between a receiver PCB 758 and the inner housing or flange 710.

The inner housing or flange 710, specifically the ring shaped portion perpendicular to the longitudinal axis of the races 702, 704 may act as a receiver shield which prevents the magnetic field generated by the transmitter coil 732 from negatively impacting electronics mounted to the receiver PCB 758. The inner housing or flange 710 may be made of aluminium.

The number of windings of the receiver coil 752 is less than the number of windings than the transmitter coil 732 although the number of windings may be the same. In this instance, the number if fewer so as to reduce loss via heat dissipation at the receiver. The span of the windings of the receiver coil 752 is less a span of the windings of the transmitter coil 732. In this way, the field generated by the transmitter coil 732 envelops the receiver coil 752 and power transfer via field coupling is maximised. The windings may be embedded or over moulded into the receiver support 754.

As illustrated in the FIG. 21 in the experimentally constructed receiver, the receiver coil 752 were coated with a resin so as to secure them to the receiver support or holder 754. This ensures mechanically stability of the windings such that rotation speeds of the inner race, housing and receiver could exceed 15,000 rpm during experimentation. The resin coating with thin enough so as to not contact the transmitter support or holder 734 during rotation which would negatively impact mechanically stability and/or power transfer.

As illustrated in FIGS. 19A and 20, the receiver further comprises a receiver PCB 758. The receiver PCB 758 may be as described. The receiver PCB 758 may be positioned on the outer surface of the inner housing or flange 710. The receiver PCB 758 may be positioned within a cavity or well of the inner housing or flange. The well may be formed at an end surface of the inner housing or flange 710. The well may be generally ring shaped and may have be perpendicular to the inner and outer races 702, 704. The well may be filled with a resin once all electronic components are affixed to the receiver PCB 758. The resin may be heat dissipating. The resin may ensure the components are physically secured to the PCB 758 even during rotation of the receiver and associated components.

Receiver electronics may be mounted on the receiver PCB 758 such as a rectifier, and DC/DC converter. The rectifier may comprise applicant's own synchronous rectifier described in U.S. Pat. No. 11,637,453 B2, the relevant portions of which are incorporated herein by reference.

In the illustrated arrangement, the electronics on the PCB 738, 758 may be embedded in a heat dissipating material. In the case of the receiver electronics, the material forms a solid puck on the receiver PCB 758 as illustrated in FIG. 21. The puck has embedded therein the receiver electronics. The puck may dissipate heat out of the components of the receiver electronics. The puck may disperse heat through the puck material.

The transmitter and receiver coils 732, 752 may be encapsulated using a two-part epoxy. As described, the described receiver coil may be encapsulated with a layer of epoxy or resin of suitable thickness which does not cause contact with the transmitter during rotation. The layer of epoxy or resin on any of the described transmitter coil may ensure the transmitter coil 732 is not damaged during assembly or use.

The transmitter and receiver supports or holders 734, 754 may be manufactured with various materials. For example, any of the described supports may be PET Polyseter resin and PEEK and polybutylene terephthalate (PBT).

It should be understood that the examples provided are merely exemplary present of the present disclosure, and that various modifications may be made thereto.

What is claimed is:

1. A bearing comprising an inner race, an outer race and one or more roller elements positioned radially between the inner and outer races, the bearing further comprising:
a wireless power transfer system affixed to at least one of the inner and outer races.

2. The bearing of claim 1, wherein the wireless power transfer system comprises a transmitter for generating a magnetic field.

3. The bearing of claim 2, wherein the transmitter comprises a coil positioned axially adjacent one of the races.

3. The bearing of claim 3, wherein the coil is mounted to a support radially adjacent one of the races.

4. The bearing claim 3, wherein the coil comprising a plurality of windings, wherein the plurality of windings are aligned in a direction parallel to a longitudinal axis of the races.

5. The bearing of claim 2, wherein the transmitter further comprises a shield for limiting the generated magnetic field.

6. The bearing of claim 5, wherein the shield is at least partially radially adjacent the coil.

7. The bearing of claim 3, wherein the transmitter further comprises electronics electrically connected to the coil.

8. The bearing of claim 7, wherein the electronics are mounted to a printed circuit board (PCB), wherein the PCB is positioned at one longitudinal end of the bearing races.

9. The bearing of claim 1, wherein the wireless power transfer system comprises a receiver from extracting electrical power from a generated magnetic field.

10. The bearing of claim 9, wherein the receiver comprises a coil positioned axially adjacent one of the races.

11. The bearing of claim 10, wherein the coil of the receiver is mounted to a support axially adjacent one of the races.

12. The bearing of claim 10, wherein the coil of the receiver comprises a plurality of windings, wherein the plurality of windings are aligned in a direction parallel to a longitudinal axis of the races.

13. The bearing of claim 9, wherein the receiver further comprises a shield for limiting a generated magnetic field.

14. The bearing of claim 13, wherein the shield of the receiver is axially adjacent a coil of the receiver.

15. The bearing of claim 8, wherein the receiver further comprises electronics electrically connected to the coil of the receiver.

16. The bearing of claim 15, wherein the electronics are mounted to a printed circuit board (PCB).

17. The bearing of claim 16, wherein the PCB of the receiver is positioned at one longitudinal end of the bearing races.

18. A motor comprising a drive shaft and the bearing of claim 1, the bearing enclosing the drive shaft.

19. A wireless power transfer system comprising:
a transmitter affixed to one of an inner and outer race of a bearing, the races enclosing one or more roller elements, the transmitter comprising a coil mounted to a support axially adjacent the at least one race of the bearing, the coil for generating a magnetic field for transferring electrical power; and
a receiver positioned affixed to another one of inner and outer race of the bearing, the receiver comprising a coil mounted to a support axially adjacent one of the bearing races, the coil of the receiver for extracting electrical power from the generated magnetic field.

20. A method of transferring electrical power wirelessly within a bearing comprising an inner race, an outer race and one or more roller elements positioned radially between the inner and outer races, the bearing further comprising a wireless power transfer system affixed to at least one of the inner and outer races, the method comprising:
generating an electrical field, via a transmitter affixed to one of the inner and outer races, to transfer electrical power to a receiver affixed to the other one of the inner and outer races.
